(19) United States
(12) Patent Application Publication
(10) Pub. No.: US 2026/0261482 A1
(43) Pub. Date: Sep. 3, 2026

(54) SYSTEMS AND METHODS FOR AUTOMATED GRAPH DATABASE (GDB) ENTITLEMENT MANAGEMENT

(71) Applicant: The Travelers Indemnity Company, Hartford, CT (US)

(72) Inventors: David Rollins, West Hartford, CT (US); David Wunderlich, Rochester, NH (US)

(21) Appl. No.: 19/068,317

(22) Filed: Mar. 3, 2025

(51) Int. Cl. H04L 41/14; G06F 16/901; H04L 9/40; H04L 41/22

(52) U.S. Cl. CPC H04L 41/145; G06F 16/9024; H04L 41/22; H04L 63/0236

(57) ABSTRACT

Systems, apparatus, methods, and articles of manufacture for GDB entitlement management that utilize a plurality of specially-programmed adapters that listen for and are responsive to react to GDB events descriptive of changes to GDB entitlement data.

### BACKGROUND

Information Technology (IT) assets have become ubiquitous to the operation of businesses in almost every industry and facet of modern society. Many organizations operate thousands or tens of thousands of IT assets including Personal Computer (PC), laptop computer, 'smart' phone, tablet, network communication, and/or other computerized devices. Managing the vast array of IT assets in use is critical to avoid redundant costs and to reduce the risk of cyberattacks. As the number of assets requiring monitoring increases, however, the task of asset management becomes exponentially complex, time consuming, and costly.

### BRIEF DESCRIPTION OF THE DRAWINGS

The figures depict embodiments for purposes of illustration only. One skilled in the art will readily recognize from the following description that alternative embodiments of the systems and methods illustrated herein may be employed without departing from the principles described herein, wherein:

FIG. 1 is a block diagram of a system according to some embodiments;

FIG. 2 is a block diagram of a system according to some embodiments;

FIG. 3 is a block diagram of a data storage structure according to some embodiments;

FIG. 4 is a block diagram of a system according to some embodiments;

FIG. 5 is a block diagram of a system according to some embodiments

FIG. 6 is a block diagram of a system according to some embodiments;

FIG. 7 is a flow diagram of a method according to some embodiments;

FIG. 8 is a flow diagram of a method according to some embodiments;

FIG. 9 is a block diagram of an apparatus according to some embodiments;

FIG. 10A, FIG. 10B, FIG. 10C, FIG. 10D, and FIG. 10E are perspective diagrams of exemplary data storage devices according to some embodiments; and

FIG. 11 is a flow diagram of an algorithm according to some embodiments.

### DETAILED DESCRIPTION

### I. Introduction

Existing Information Technology (IT) asset management systems allow users to record and store data descriptive of an organization's various IT components (e.g., "entitlements"). Typically, these systems employ either flat-file (e.g., spreadsheet) data storage or relational databases that permit large amounts of asset data to be stored in efficient and easily-queried manners. While the relational databases often utilized do permit efficient storage of large quantities of descriptive data, they are limited with respect to the relational mapping between different assets, and they do not necessarily reflect real-world conditions. Queries of such systems can overtax system resources as their relational data storage structures are inefficient (or even incapable) of storing data representing complex inter-node relationships.

In accordance with embodiments herein, these and other deficiencies of existing systems are remedied by providing systems, apparatus, methods, and articles of manufacture for automated Graph DataBase (GDB) entitlement management. In some embodiments, for example, IT asset data (e.g., entitlement data) may be stored in a GDB repository in a manner that captures and represents complex relationships between IT asset nodes and that is specially-programmed to automatically synchronize and manage real-world tie-ins for the stored data assets and/or relationships. According to some embodiments, the GDB entitlement management system may utilize a plurality of plugins that are each specially-programmed to validate and/or execute a real-world setting or change thereof, in response to a particular event occurring within the GDB.

### II. GDB Entitlement Management Systems

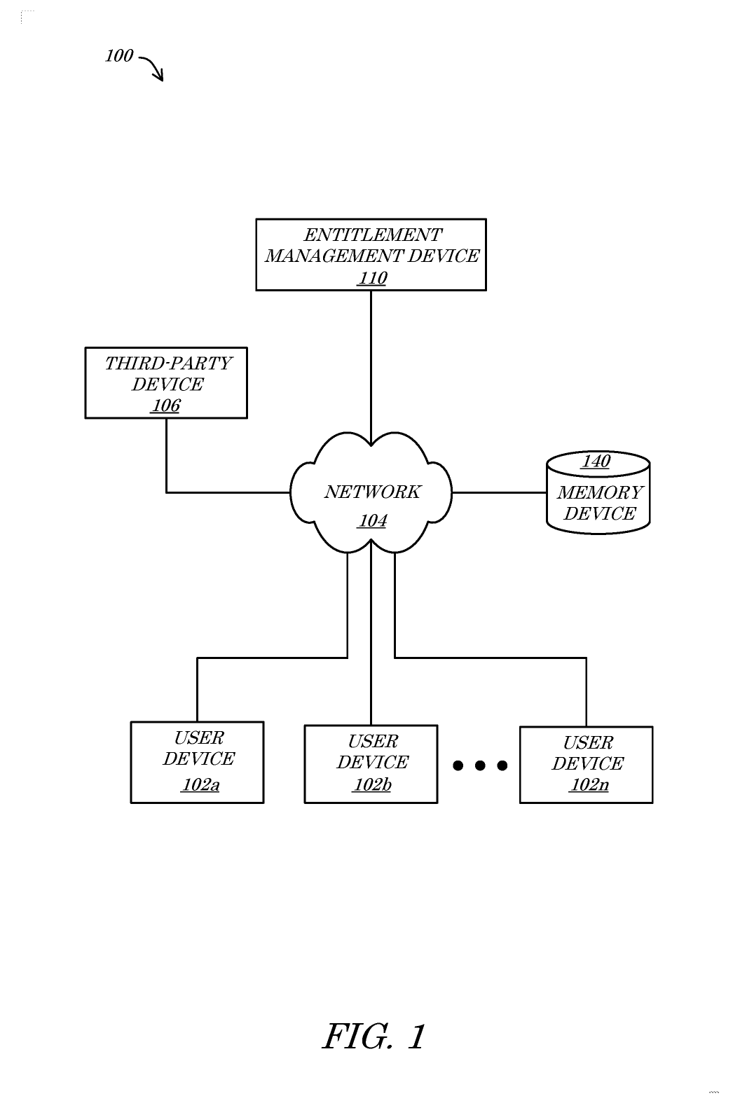

Referring first to FIG. 1, a block diagram of a system 100 according to some embodiments is shown. In some embodiments, the system 100 may comprise a plurality of user devices 102a-n, a network 104, a third-party device 106, and/or an entitlement management device (e.g., controller) 110. According to some embodiments, any or all of the components 102a-n, 106, 110 may comprise and/or be in communication with a data storage and/or memory device 140. The third-party device 106, the entitlement management device 110, and/or the user devices 102a-n may, for example, comprise and/or have access to the memory device 140. As depicted in FIG. 1, any or all of the components 102a-n, 106, 110, 140 (or any combinations thereof) may be in communication via the network 104. In some embodiments, communications between and/or within the components 102a-n, 106, 110, 140 of the system 100 may be utilized to provide a GDB entitlement management platform as described herein. The entitlement management device 110 may, for example, interface with one or more of the user devices 102a-n and/or the third-party device 106 to execute graph queries, GDB event listeners, and/or Large Language Model (LLM) instances (none of which are depicted in FIG. 1) stored in the memory device 140 and/or provide a specially-structured interface via which a user (not separately shown; e.g., of a user device 102a-n) may access and/or utilize GDB entitlement management services provided by the entitlement management device 110.

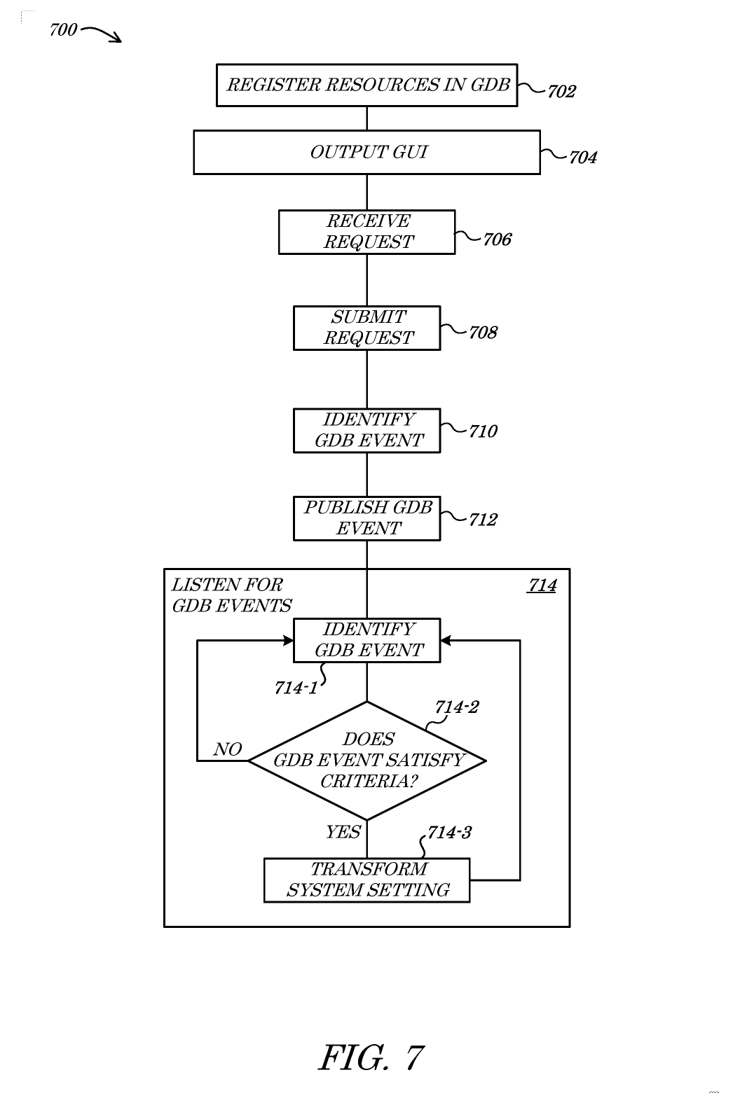

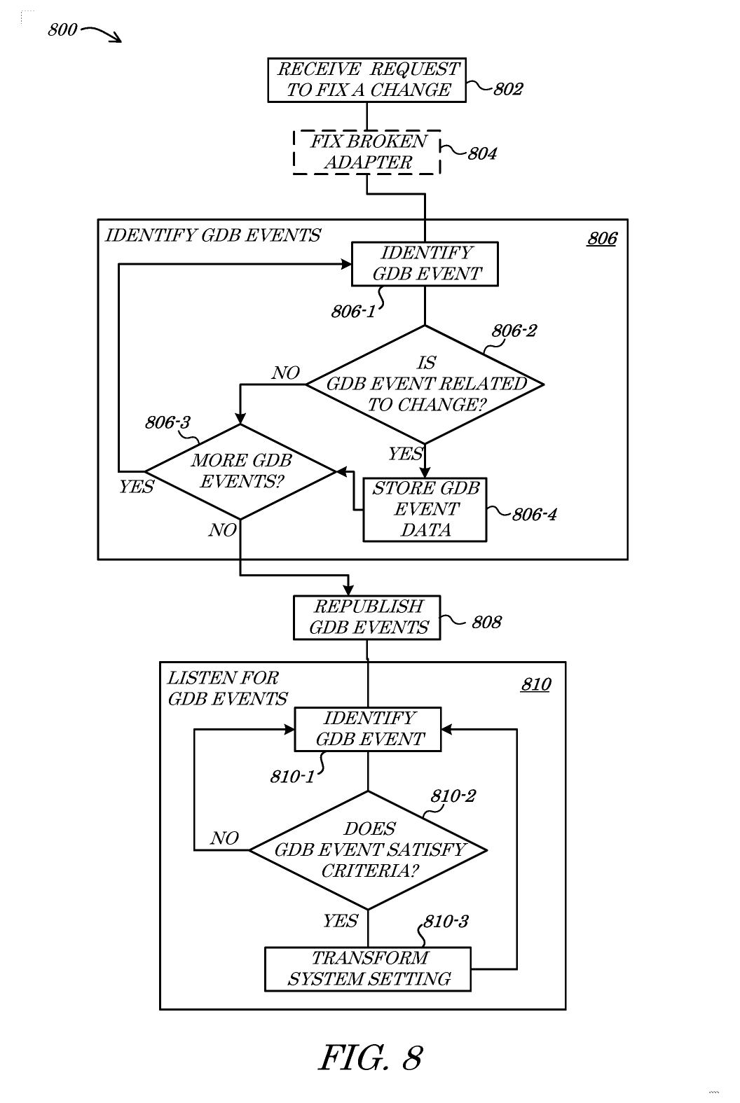

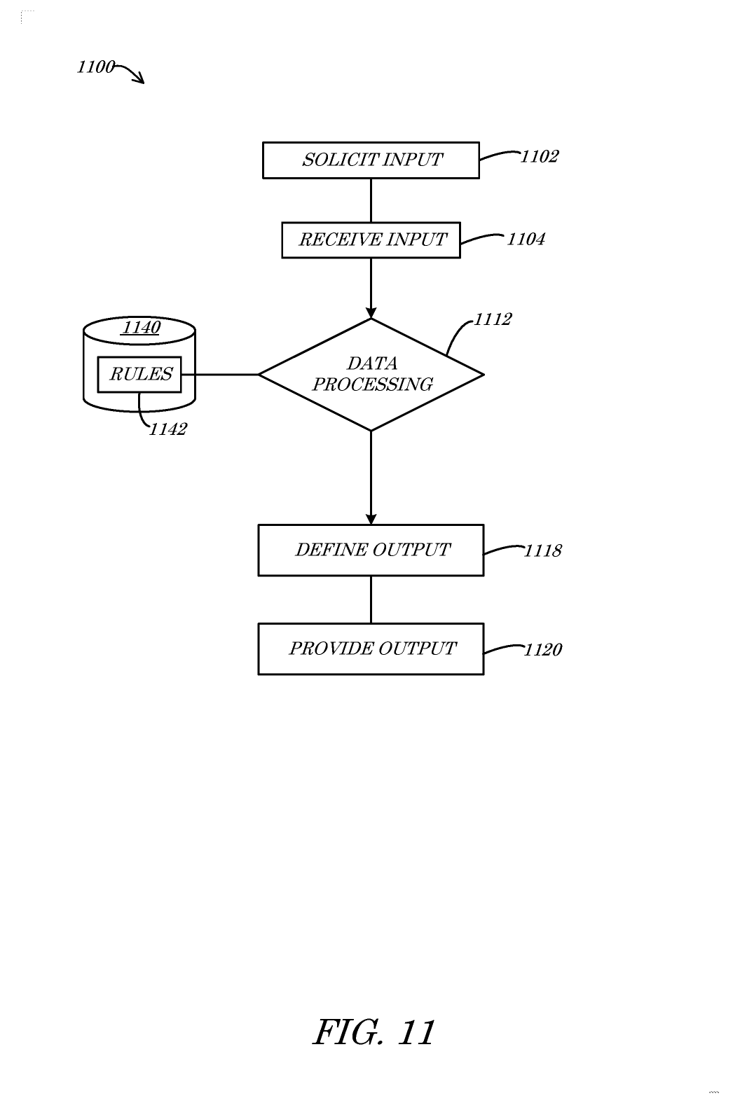

Fewer or more components 102a-n, 104, 106, 110, 140 and/or various configurations of the depicted components 102a-n, 104, 106, 110, 140 may be included in the system 100 without deviating from the scope of embodiments described herein. In some embodiments, the components 102a-n, 104, 106, 110, 140 may be similar in configuration and/or functionality to similarly named and/or numbered components as described herein. In some embodiments, the system 100 (and/or portions thereof) may comprise a GDB entitlement management program, system, and/or platform programmed and/or otherwise configured to execute, conduct, and/or facilitate the methods/algorithms 700, 800,1100 of FIG. 7, FIG. 8, and/or FIG. 11 herein, and/or portions or combinations thereof.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations (e.g., an enterprise employee workstation), tablet computers, such as an iPad©manufactured by Apple@, Inc. of Cupertino, CA, and/or cellular and/or wireless telephones, such as an iPhone@ (also manufactured by Apple@, Inc.) or an LG G8^{T}M ThinQ^{T}M smart phone manufactured by LG@ Electronics, Inc. of San Diego, CA, and running the Android@ operating system from Google@, Inc. of Mountain View, CA. In some embodiments, the user devices 102a-n may comprise devices owned and/or operated by one or more users, such as code developers, business analysts, employees, and/or consultants or service providers. According to some embodiments, the user devices 102a-n may communicate with the entitlement management device 110 directly and/or via the network 104 to provide requests to retrieve, edit, and/or delete entitlement data, e.g., in accordance with GDB entitlement management processes as described herein. According to some embodiments, any of the user devices 102a-n may communicate with the third-party device 106 through and/or via the entitlement management device 110. The entitlement management device 110 may, for example, execute one or more of (i) a graph analysis, query, and/or database management tool, (ii) one or more event listeners, and/or (iii) one or more trained LLM instances, stored in the memory device 140, e.g., to coordinate one or more real-world settings/actions corresponding to a particular entitlement related to the request, as described herein. In some embodiments, the user devices 102a-n may interface with the entitlement management device 110 to effectuate communications (direct or indirect) with one or more other user devices 102a-n (such communication not explicitly shown in FIG. 1) operated by other users.

The network 104 may, according to some embodiments, comprise a Local Area Network (LAN; wireless and/or wired), cellular telephone, Bluetooth@, Near Field Communication (NFC), and/or Radio Frequency (RF) network with communication links between the entitlement management device 110, the user devices 102a-n, the third-party device 106, and/or the memory device 140. In some embodiments, the network 104 may comprise direct communication links between any or all of the components 102a- n, 106, 110, 140 of the system 100. The user devices 102a-n may, for example, be directly interfaced orconnected to one or more of the entitlement management device 110 and/or the memory device 140 via one or more wires, cables, wireless links, and/or other network components, such network components (e.g., communication links) comprising portions of the network 104. In some embodiments, the network 104 may comprise one or many other links or network components other than those depicted in FIG. 1. The entitlement management device 110 may, for example, be connected to the third-party device 106 and/or the user devices 102a-n via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110,140 of the system 100. The network 104 may comprise one or more cellular telephone networks with communication links between the user devices 102a-n and the entitlement management device 110, for example, and/or may comprise the Internet, with communication links between the entitlement management device 110 and the third-party device 106 and/or the memory device 140, for example.

The third-party device 106, in some embodiments, may comprise any type or configuration of a computerized processing device, such as a PC, laptop computer, computer server, database system, and/or other electronic device, devices, or any combination thereof. In some embodiments, the third-party device 106 may be owned and/or operated by a third-party (i.e., an entity different than any entity owning and/or operating either the user devices 102a-n or the entitlement management device 110, such as an Information Technology (IT) and/or Artificial Intelligence (AI) service provider). The third-party device 106 may, for example, execute one or more graph analytics and/or AI-based web services that provide GDB hosting, querying, and/or management services and/or LLM data processing. According to some embodiments, the third-party device 106 may comprise a plurality of devices and/or may be associated with a plurality of third-party entities and/or services (e.g., cloud services).

In some embodiments, the entitlement management device 110 may comprise an electronic and/or computerized controller device, such as a computer server communicatively coupled to interface with the user devices 102a-n and/or the third-party device 106 (directly and/or indirectly). The entitlement management device 110 may, for example, comprise one or more PowerEdgeTM R960 rack servers manufactured by Dell@, Inc. of Round Rock, TX, which may include one or more multi-core Intel@Xeon@ Scalable Processor and/or Graphical Processing Unit (GPU) devices (e.g., sixty (60) cores total). In some embodiments, the entitlement management device 110 may comprise a plurality of processing devices specially-programmed to execute and/or conduct processes that are not practicable without the aid of the entitlement management device 110. The entitlement management device 110 may, for example, train and/or execute one or more event listener, event adapter, AI, LLM, and/or Machine Learning (ML) models (e.g., stored in the memory device 140) that provide GDB management services for accessing, querying, editing, and/or deleting entitlement data for one or more IT environments comprising a plurality of complex IT asset relationships, which would not be capable of being conducted without the benefit of the specially- programmed entitlement management device 110. According to some embodiments, the entitlement management device 110 may be located remotely from one or more of the user devices 102a-n and/or the third-party device 106. The entitlement management device 110 may also or alternatively comprise a plurality of electronic processing devices located at one or more various sites and/or locations (e.g., distributed and/or virtual computing).

According to some embodiments, the entitlement management device 110 may store and/or execute specially programmed instructions to operate in accordance with embodiments described herein. The entitlement management device 110 may, for example, execute one or more models (e.g., LLM/AI models), algorithms, programs, modules, and/or routines that facilitate and/or enable GDB entitlement management. According to some embodiments, the entitlement management device 110 may comprise a computerized processing device, such as a computer server and/or other electronic device, to manage stored entitlement data based on requests received from one or more of the user devices 102a-n. An enterprise user, corporate employee, agent, business analyst, IT professional, coder, and/or other user may, for example, utilize the entitlement management device 110 to (i) prepare, identify, send (and/or receive), and/or generate an entitlement search and/or change request, (ii) identify GDB data related to the request, (iii) identify one or more nodes and/or relationships represented by the GDB data, (iv) identify GDB events related to the GDB data, (v) publish GDB events, (vi) listen for GDB events, (vii) compare GDB event data to event criteria, (viii) transform system settings based on GDB events, (ix) prepare, identify, send (and/or receive), and/or generate a request to fix a set of GDB events, (x) identify the set of GDB events to fix, (xi) identify an specially-programmed adapter to fix, (xii) fix the specially- programmed adapter, (xiii) republish the identified GDB events to fix, and/or (xiv) reprocess the republished GDB events by the fixed specially-programmed adapter, as described herein.

In some embodiments, the user devices 102a-n, the third-party device 106, and/or the entitlement management device 110 may be in communication with the memory device 140. The memory device 140 may comprise, for example, various databases and/or data storage mediums that may store, for example, data descriptive of the user devices 102a-n, user preference and/or characteristics data, historic user, user device 102a-n, entitlement management request, and/or GDB data, geolocation data, historic entitlement changelevent data, LLM instance and/or Al models, chain code instructions, blockchain data, cryptographic keys and/or data, login and/or identity credentials, and/or instructions thatcause various devices (e.g., the entitlement management device 110, the third-party device 106, and/or the user devices 102a-n) to operate in accordance with embodiments described herein.

The memory device 140 may store, for example, GDB entitlement management instructions and/or models, chain code instructions, and/or data that causes GDB entitlement management, such as automatic synchronization of GDB entitlement data and real-world settings. In some embodiments, the memory device 140 may comprise any type, configuration, and/or quantity of data storage devices that are or become known or practicable. The memory device 140 may, for example, comprise an array of optical and/or solid-state hard drives configured to store GDB entitlement management data provided by (and/or requested by) the user devices 102a-n, GDB data (e.g., nodes, variables, database fields, logical routines, calculations, and/or formulas), request data (e.g., communication data), LLM data (e.g., defining LLM characteristics, types, training sets, etc.), and/or various operating instructions, drivers, etc. While the memory device 140 is depicted as a standalone component disembodied from (but in communication with) the various user devices 102a-n and the entitlement management device 110, the memory device 140 may comprise multiple components and/or may be part of any or all of the user devices 102a-n and the entitlement management device 110. In some embodiments, multi-component memory devices 140 may be distributed across various devices and/or may comprise remotely dispersed components. Any or all of the user devices 102a-n, the third-party device 106, and/or the entitlement management device 110 may comprise the memory device 140 or a portion thereof, for example.

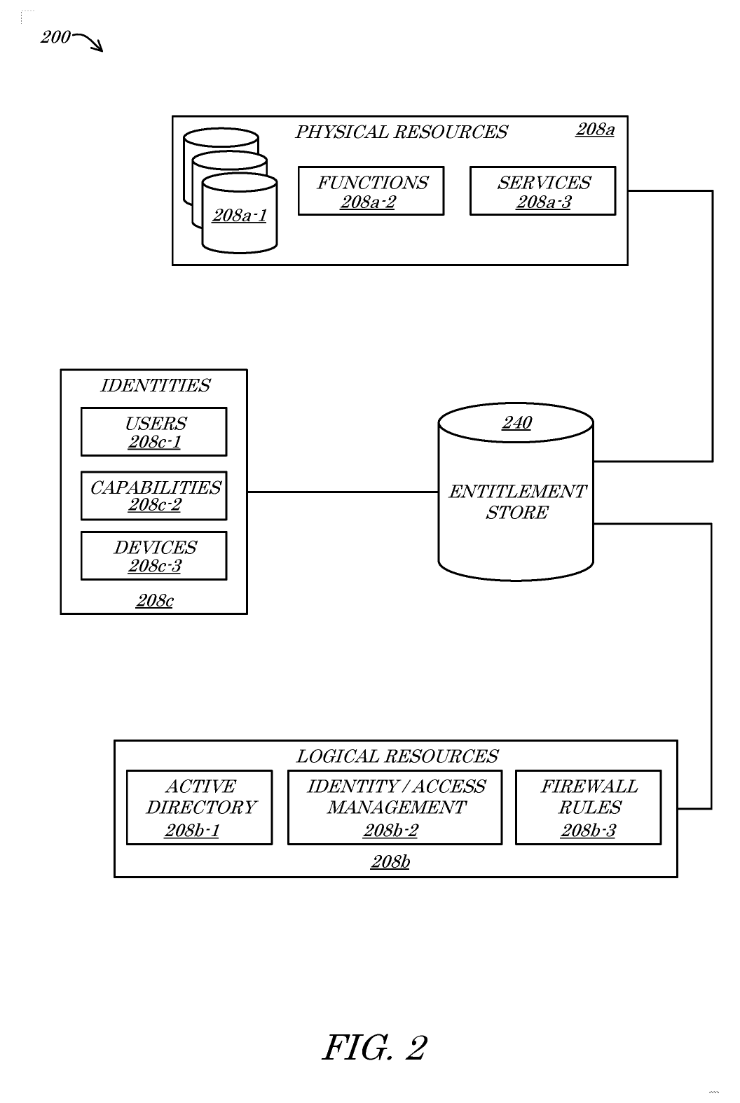

Turning now to FIG. 2, a block diagram of a system 200 according to some embodiments is shown. In some embodiments, the system 200 may comprise a representation of a resource registration matrix in which a plurality of different types of resources (e.g., entitlements) 208a-c are in communication with, communicated to, and/or stored in an entitlement store 240. According to some embodiments, the entitlement store 240 may comprise a GDB data storage structure and/or one or more GDB instances. In some embodiments, a first set of entitlements 208a may comprise physical resources, such as, but not limited to, various data storage structures, devices, and/or databases 208a-1, functions 208a-2, and/or services 208a-3. According to some embodiments, a second set of entitlements 208b may comprise logical resources, such as, but not limited to, one or more Active Directory (AD) instances 208b-1, identity and/or access management resources 208b-2, and/or firewall settings or rules 208b-3. In some embodiments, a third set of entitlements 208c may comprise various identities, such as, but not limited to, identification information, data, settings, instances, and/or entities for one or more users 208c-1, capabilities 208c-2, and/or devices 208c-3.

In some embodiments, data descriptive of the entitlements 208a-c may be stored (e.g., via a registration process) in the entitlement store 240. According to some embodiments, each of the stored entitlements 208a-c may comprise one or more nodes in a GDB of the entitlement store 240. In some embodiments, the entitlements 208a-c may represent assets and/or resources of an IT environment (not separately shown), such as all assets and/or resources that define and/or are members of a corporate or enterprise IT infrastructure. In some embodiments, data records descriptive of each entitlement 208a-c may be stored or registered in the entitlement store 240 as a result of a node establishment process or procedure, e.g., as described herein.

Fewer or more components 208a-c, 208a-1, 208a-2, 208a-3, 208b-1, 208b-2, 208b-3, 208c-1, 208c-2, 208c-3, 240 and/or various configurations of the depicted components 208a-c, 208a-1, 208a-2, 208a-3, 208b-1, 208b-2, 208b-3, 208c-1, 208c-2, 208c-3, 240 may be included in the system 200 without deviating from the scope of embodiments described herein. In some embodiments, the components 208a-c, 208a-1, 208a-2, 208a-3, 208b-1, 208b-2, 208b-3, 208c-1, 208c-2,208c-3, 240 may be similar in configuration and/or functionality to similarly named and/or numbered components as described herein. In some embodiments, the system 200 (and/or portions thereof) may comprise a GDB entitlement management program, system, and/or platform programmed and/or otherwise configured to execute, conduct, and/or facilitate the methods/algorithms 700, 800, 1100 of FIG. 7, FIG. 8, and/or FIG. 11 herein, and/or portions or combinations thereof.

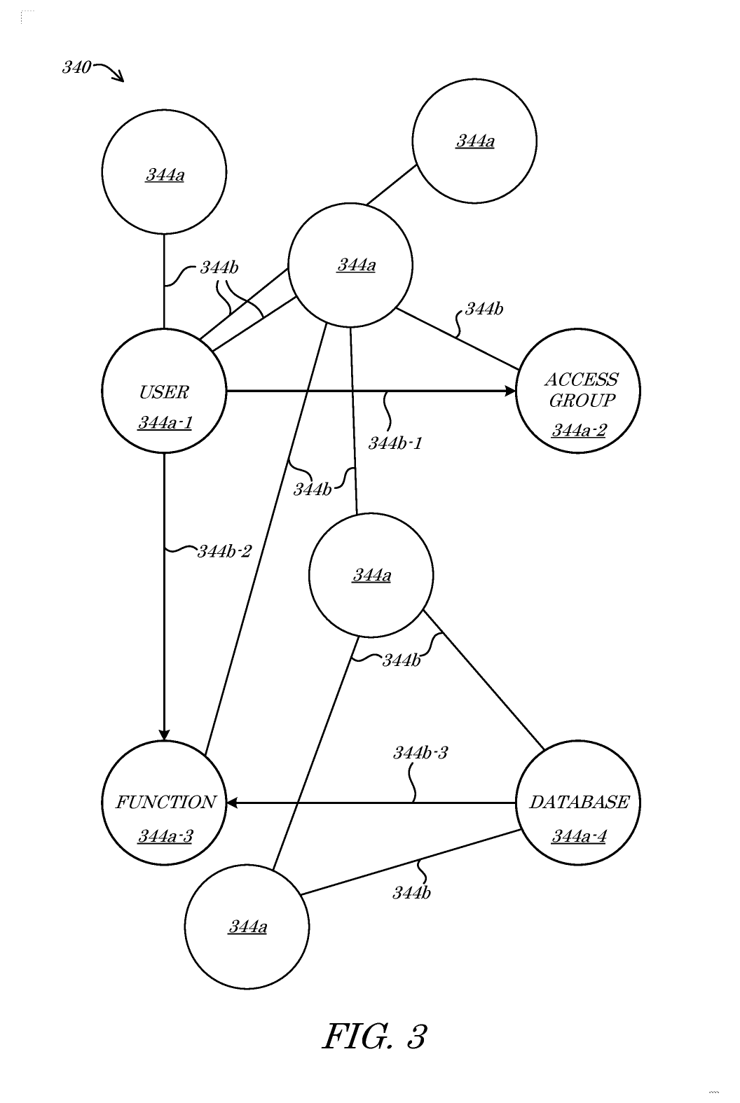

Referring now to FIG. 3, a block diagram of a data storage structure 340 according to some embodiments is shown. In some embodiments, the data storage structure 340 may comprise a visual representation of a resource registration matrix in which a plurality of different types of resource data nodes 344a and associated relationships 344b are represented. As depicted for purposes of non-limiting example, the relationships 344b between the various nodes 344a may be complex. In practice, a typical IT system (not separately shown) may comprise thousands of nodes 344a and many thousands of relationships 344b therebetween. In some embodiments, the data storage structure 340 may comprise a GDB instance (or portion thereof), such as a GDB provided by Neo4j@, Inc. of San Mateo, CA and/or an Amazon@ Neptune TM-managed GDB provided by Amazon.com@, Inc. of Seattle, WA.

In one example depicted in FIG. 3, the data storage structure 340 may store data descriptive of a first or user node 344a-1, a second or Access Group node 344a-2, a third or function node 344a-3, and/or a fourth or database node 344a-4. According to some embodiments, a first relationship 344b-1 may exist between the user node 344a-1 and the Access Group node 344a-2. The user represented by the user node 344a-1 may, for example, be a member of the Access group represented by the Access Group node 344a-2, and the first relationship 344b-1 may comprise an identification and/or representation of the membership relationship between the user and the Access group. In some embodiments, a secondrelationship 344b-2 may exist between the user node 344a-1 and the function node 344a-3. The second relationship 344b-2 may, for example, comprise a service and/or resource (e.g., a capability) that enables the user to access stored data (e.g., a query tool). According to some embodiments, the second relationship 344b-2 may be dependent upon and/or contingent upon (or otherwise related to) the first relationship 344b-1. The capability provide by the function node 344a-3 may, for example, be exclusively provided (e.g., access granted) to users that are members of the Access group.

In some embodiments, the function node 344a-3 may have a third relationship 344b-3 with the database node 344a-4. The third relationship 344b-3 may, for example, comprise read access permission to any data (not shown) stored in (or in relation to) the database node 344a-4. According to some embodiments, the third relationship 344b-3 may be dependent upon and/or contingent upon (or otherwise related to) the first relationship 344b-1. The capability (e.g., access connections and/or permissions) provided and/or defined by third relationship 344b-3 may, for example, be exclusively provided to users that are members of the Access group and/or specific users within the Access group.

Fewer or more components 344a-b, 344a-1, 344a-2, 344a-3, 344a-4, 344b-1, 344b-2, 344b-3 and/or various configurations of the depicted components 344a-b, 344a-1, 344a-2, 344a-3, 344a-4, 344b- 1, 344b-2, 344b-3 may be included in the data storage structure 340 without deviating from the scope of embodiments described herein. In some embodiments, the components 344a-b, 344a-1, 344a-2, 344a- 3, 344a-4, 344b-1,344b-2, 344b-3 may be similar in configuration and/or functionality to similarly named and/or numbered components as described herein. In some embodiments, the data storage structure 340 (and/or portions thereof) may comprise a GDB entitlement management program, system, and/or platform programmed and/or otherwise configured to execute, conduct, and/or facilitate the methods/algorithms 700, 800, 1100 of FIG. 7, FIG. 8, and/or FIG. 11 herein, and/or portions or combinations thereof.

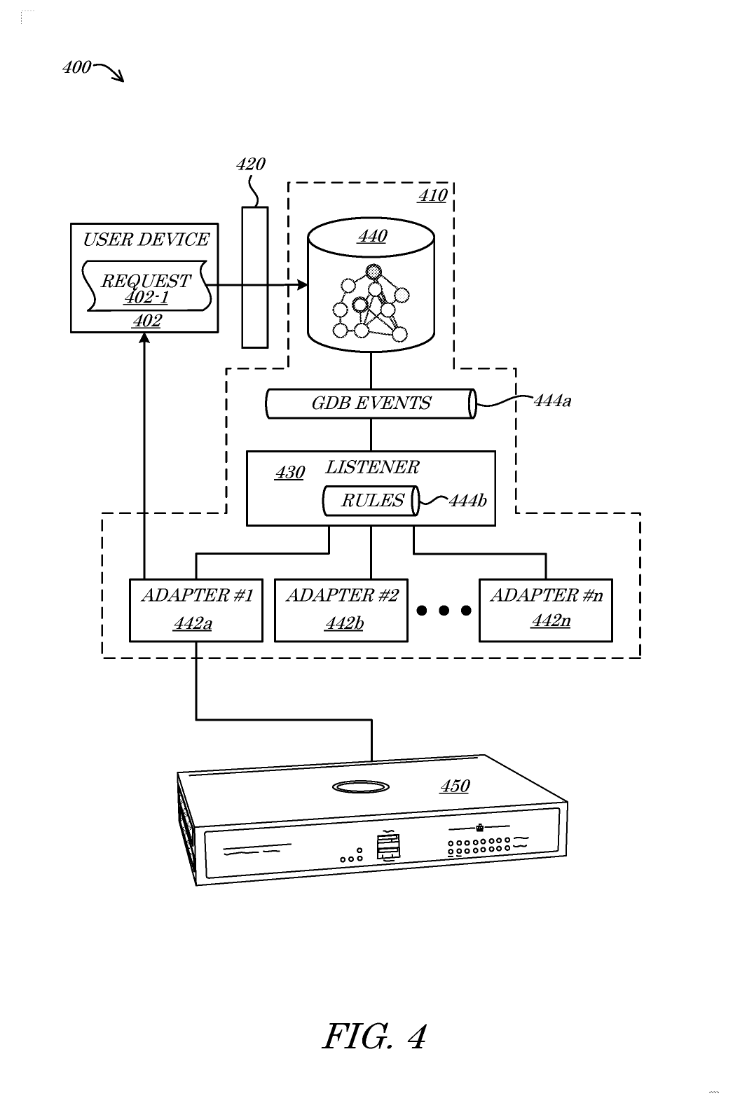

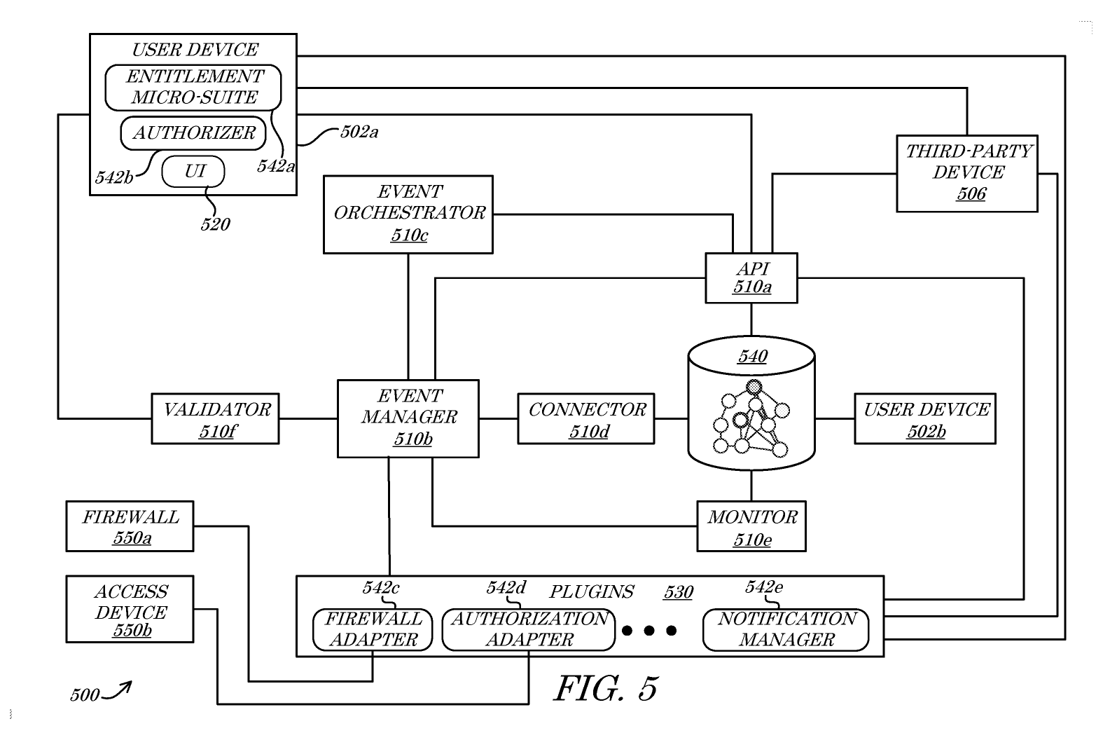

Turning now to FIG. 4, a block diagram of a system 400 according to some embodiments is shown. In some embodiments, the system 400 may comprise a GDB entitlement management system that enables a user device 402 to automatically and efficiently establish, modify, and/or delete entitlements of an IT infrastructure. The system 400 may comprise and/or be in communication with, for example, a user device 402 that defines, selects, identifies, and/or otherwise provides a request 402-1 to an entitlement management device 410. According to some embodiments, the user device 402 may be utilized, for example, to provide the request 402-1 directed to managing an entitlement to the entitlement management device 410. In some embodiments, the entitlement management device 410 may generate, comprise, and/or conduct communications with the user device 402 through an interface 420. The interface 420 may, for example, comprise a Graphical User Interface (GUI) generated and/or executed on the user device 402 (and/or the entitlement management device 410) that enables a user (not shown) of the user device 402 to define and/or submit the request 402-1 (e.g., including prompts and/or queries), and/or via which responses to such requests 402-1 are received and/or output. In some embodiments, such as in a case where the request 402-1 is generated and/or submitted by a non-human user such as an application (e.g., an AI-powered software application) or service, the interface 420 may not be required or may comprise a non-GUI interface mechanism such as an application-to-application communication interface. According to some embodiments, the entitlement management device 410 (and/or the user device 402) may comprise and/or be in communication with a listener 430 (e.g., an event bus external from a GDB 440) that is operatively and/or communicatively coupled to detect and/or respond to data associated with the GDB 440. The GDB 440 may store, in some embodiments, data descriptive of various IT infrastructure nodes and relationships, e.g., such as the nodes 344a and/or relationships 344b of FIG. 3 herein. In some embodiments, the GDB 440 (and/or a separate memory device; not shown) may store instructions, algorithms, models, and/or code that is, e.g., executable by the entitlement management device 410 (and/or one or more processing devices and/or cores of a processing device array; not separately shown).

According to some embodiments, the request 402-1 may define one or more nodes and/or relationships and one or more requested actions, such as add, modify, and/or delete. As a non-limiting example, the request 402-1 may comprise instructions to give a particular user or application access to a particular service or other application. In such an example, the request 402-1 may identify the user or application and the particular service or other application. In some embodiments, the request 402-1 may include data that defines how various nodes and/or relationships should be changed to satisfy the request 402-1. In the example, the request 402-1 may identify and/or define various credentials, permissions, and/or settings (such as a firewall setting) that should be established and/or modified to permit the requested functionality in the system 400 (and/or in a target IT system, not separately shown).

In some embodiments, each action (establish/create, modify/edit, delete/remove) in which data is changed (added, edited, and/or deleted) in the GDB 440 may cause and/or trigger one or more GDB events 444a to be generated and/or stored. According to some embodiments, the listener 430 may be communicatively coupled to listen for (e.g., detect) and/or identify one or more GDB events 444a. In some embodiments, the listener 430 may comprise and/or be operated in accordance with rules 444b that map GDB events 444a having specific characteristics to specific and specially-coded actions. The rules 444b may, for example, identify certain types of GBD events 444a, GDB events 444a occurring at certain times, with respect to certain nodes and/or relationships, etc. In some embodiments, the rules 444b may define and/or invoke one or more actions for each identified GDB event 444a and/or subset of GDB events 444a. In some embodiments, the actions may comprise "real-world" actions that are to be conducted externally to the GDB 440.

According to some embodiments, a plurality of plugins or adapters 442a-n (e.g., specially-coded applications) may be in communication with the listener 430 and may be responsive to triggers and/or commands provided by the listener 430 that are based on execution of the rules 444b. In some embodiments, each adapter 442a-n may be specially-coded to manage a specific real-world event in response to a particular GDB event 444a (e.g., a GDB event 444a having a specific set or matrix of parameter values and/or characteristics). In the case of the example depicted in FIG. 4, a first adapter 442a may, for example, be specially-coded to respond to GDB events 444a that involve and/or require communication settings to be changed. In one specific example, the request 402-1 may involve a change to a setting of a firewall device 450, and a GDB event 444a descriptive of the firewall setting change may be triggered within the GDB 440. In some embodiments, the listener 430 may identify the GDB event 444a descriptive of the firewall setting change and may process the GDB event 444a (and/or data descriptive thereof) utilizing the rules 444b to determine that a specific rule 444b (and/or criteria) exists that matches and/or is triggered by the GDB event 444a descriptive of the firewall setting change.

In some embodiments, the listener 430 may call and/or invoke the first adapter 442a and/or may pass data descriptive of the triggering GDB event 444a descriptive of the firewall setting change to the first adapter 442a. According to some embodiments, the first adapter 442a may be executed (e.g., by the entitlement management device 410) by utilizing the GDB event 444a descriptive of the firewall setting change to send a command and/or control signal to the firewall device 450. In such a manner, for example, any change made within the GDB 440 may be automatically synchronized with real-world devices and/or settings.

According to some embodiments, the entitlement management device 410 and/or the first adapter 442a may send a confirmation to the user device 402 upon automatic synchronization of the settings of the firewall device 450 (with respect to the illustrated example) with the changes to the GDB 440 committed with respect to (e.g., in response to) the request 402-1. In some embodiments, the confirmation and/or output may be provided via the interface 420 (although not shown in FIG. 4), e.g., in a graphical fashion. In some embodiments, the output may alternatively comprise an indication of an error and/or misalignment with the data stored in the GDB 440 and the real-world setting (e.g., a particular port of the firewall device 450 being opened, closed, and/or otherwise configured). In such a manner, for example, the user may be readily notified of any discrepancies in the system 400 with respect to entitlement settings and/or configurations.

Fewer or more components 402, 402-1, 410, 420, 430, 440, 442a-n, 444a-b, 450 and/or various configurations of the depicted components 402, 402-1, 410, 420, 430, 440, 442a-n, 444a-b, 450 may be included in the system 400 without deviating from the scope of embodiments described herein. In some embodiments, the components 402, 402-1, 410, 420, 430, 440, 442a-n, 444a-b, 450 may be similar in configuration and/or functionality to similarly named and/or numbered components as described herein. In some embodiments, the system 400 (and/or portions thereof) may comprise a GDB entitlement management program, system, and/or platform programmed and/or otherwise configured to execute, conduct, and/or facilitate the methods/algorithms 700, 800, 1100 of FIG. 7, FIG. 8, and/or FIG. 11 herein, and/or portions or combinations thereof.

Referring now to FIG. 5, a block diagram of a system 500 according to some embodiments is shown. In some embodiments, the system 500 may comprise a GDB entitlement management system that enables one or more users (not explicitly shown) to automatically and efficiently establish, modify, and/or delete entitlements of an IT infrastructure. The system 500 may comprise and/or be in communication with, for example, a first user device 502a and/or a second user device 502b, each of which may be in communication with a third-party device 506 and/or various GDB entitlement management components, such as an Application Programming Interface (API) 510a, an event manager 510b, an event orchestrator 510c, a connector 510d, a monitor 510e, and/or a validator 510f. In some embodiments, the first user device 502a may comprise a device operated by an end-user (not shown) that provides input, such as entitlement data viewing and/or modification requests (not separately shown; e.g., the request 402-1 of FIG. 4, herein), via a User Interface (UI) 520.

According to some embodiments, the UI 520 may send request data (e.g., input) to the API 510a and/or may request and/or trigger data from the third-party device 506 (e.g., third-party permissions and/or other third-party data) to be sent to (and/or acquired by) the API 510a. In some embodiments, the API 510a may be in communication with a suite of plugins 530 and/or a GDB 540. According to some embodiments, in response to the request, the API 510a may send a query and/or change request to the GDB 540. The request may identify one or more nodes and/or relationships for viewing/retrieval and/or editing, for example, and the API 510a may send one or more corresponding signals to the GDB 540 to implement the request. According to some embodiments, the second user device 502b may be utilized (e.g., by a different user; e.g., a database administrator and/or "super" user) to make changes directly to the data stored in the GDB 540.

In some embodiments, the connector 510d may comprise a specially-programmed bridge that listens for events within a change stream of the GDB 540 and reports them to the event manager 510b. According to some embodiments, the event manager 510b may comprise an event bus that publishes GDB events as reported from the connector 510d. In some embodiments, the system 500 may comprise a plurality of programs, modules, processes, and/or models that are selectively executed (e.g., by a processing device) to perform functions as described herein. In some embodiments, the first user device 502a may comprise an entitlement micro-suite 542a and/or an authorizer 542b, for example, and/or the plugins 530 may comprise and/or define a firewall adapter 542c, an authorization adapter 542d, and/or a notification manager 542e.

According to some embodiments, the entitlement micro-suite 542a and/or the authorizer 542b may comprise client-side programs that enable the user to interact with the API 510a to structure and/or submit entitlement management requests. The entitlement micro-suite 542a and/or the authorizer 542b may, for example, generate and/or coordinate with the UI 520 to enable the user to select specific entitlement nodes and/or relationships as stored and defined in the GDB 540. According to some embodiments, the entitlement micro-suite 542a may be programmed to enable the user to submit requests to establish, modify, and/or delete one or more entitlements, while the authorizer 542b may be programmed to communicate with the third-party device 506 to obtain permissions or authorizations for entitlement viewing, usage, and/or changes.

In some embodiments, the firewall adapter 542c and the authorization adapter 542d may be specially-programmed to be responsive to particular types of GDB events, e.g., as published by the event manager 510b. The firewall adapter 542c may, for example, be specially-programmed to be responsive to changes in entitlement data that are associated with changes to one or more settings of a firewall 550a. In some embodiments, the firewall adapter 542c may, upon detection of a published GDB event that matches stored criteria for the firewall adapter 542c, send a command and/or control signal to the firewall 550a that cause one or more settings of the firewall 550a to be set in accordance with the published GDB event data. According to some embodiments, the authorization adapter 542d may be specially- programmed to be responsive to changes in entitlement data that are associated with changes to one or more settings of an access device 550b. In some embodiments, the authorization adapter 542d may, upon detection of a published GDB event that matches stored criteria for the authorization adapter 542d, send a command and/or control signal to the access device 550b that cause one or more settings of the access device 550b to be set in accordance with the published GDB event data.

According to some embodiments, the monitor 510e may be programmed to automatically compare entitlement data to real-world settings and/or to monitor changes to entitlement data. The monitor 510e may identify and/or check any relationship (and/or node) that is labeled as "pending", for example, to ensure that a request for the change/setting has not timed-out. The monitor 510e may generate events descriptive of comparison results (e.g., a non-GDB event) and send the events to the event manager 510b for publication. In some embodiments, the notification manager 542e may listen for non-GDB events, such as events triggered by the monitor 510e and/or error or alert events triggered and/or generated by one or more of the adapters 542c-d. According to some embodiments, the notification manager 542e may alert a user (e.g., by sending a signal to the first user device 502a) of any non-GDB events.

In some embodiments, the event orchestrator 510c may subscribe to publications from the event manager 510b and may utilize the published event (e.g., GDB event and non-GDB event) data to update the API 510a and/or the UI 520, e.g., to enable the user to visualize real-time settings/changes to entitlement nodes and/or relationships. According to some embodiments, the validator 510f may provide entitlement node and/or relationship validation services (e.g., to the first user device 502a). The validator 510f may, for example, automatically execute on a periodic schedule to provide the user with data summarizing validation results for active and/or pending entitlement nodes and/or relationships. In some embodiments, the validator 510f and/or the system 500 may provide entitlement viewing and/or navigating capabilities via a GDB query tool (e.g., presented via the UI 520), such as the GUI graph analytic viewing and interaction capabilities described in co-pending U.S. Patent Application No. 18/181132 filed on March 9, 2023 and titled "SYSTEMS AND METHODS FOR APPLICATION AND DATA DEPENDENCY IDENTIFICATION, VISUALIZATION, AND MANAGEMENT", the GDB viewing and GUI concepts and descriptions of which are hereby incorporated by reference herein.

Fewer or more components 502a-b, 506, 510a-f, 520, 530, 540, 542a-e, 550a-b and/or various configurations of the depicted components 502a-b, 506, 510a-f, 520, 530, 540, 542a-e, 550a-b may be included in the system 500 without deviating from the scope of embodiments described herein. In some embodiments, the components 502a-b, 506, 510a-f,520, 530, 540, 542a-e, 550a-b may be similar in configuration and/or functionality to similarly named and/or numbered components as described herein. In some embodiments, the system 500 (and/or portions thereof) may comprise a GDB entitlement management program, system, and/or platform programmed and/or otherwise configured to execute, conduct, and/or facilitate the methods/algorithms 700, 800, 1100 of FIG. 7, FIG. 8, and/or FIG. 11 herein, and/or portions or combinations thereof.

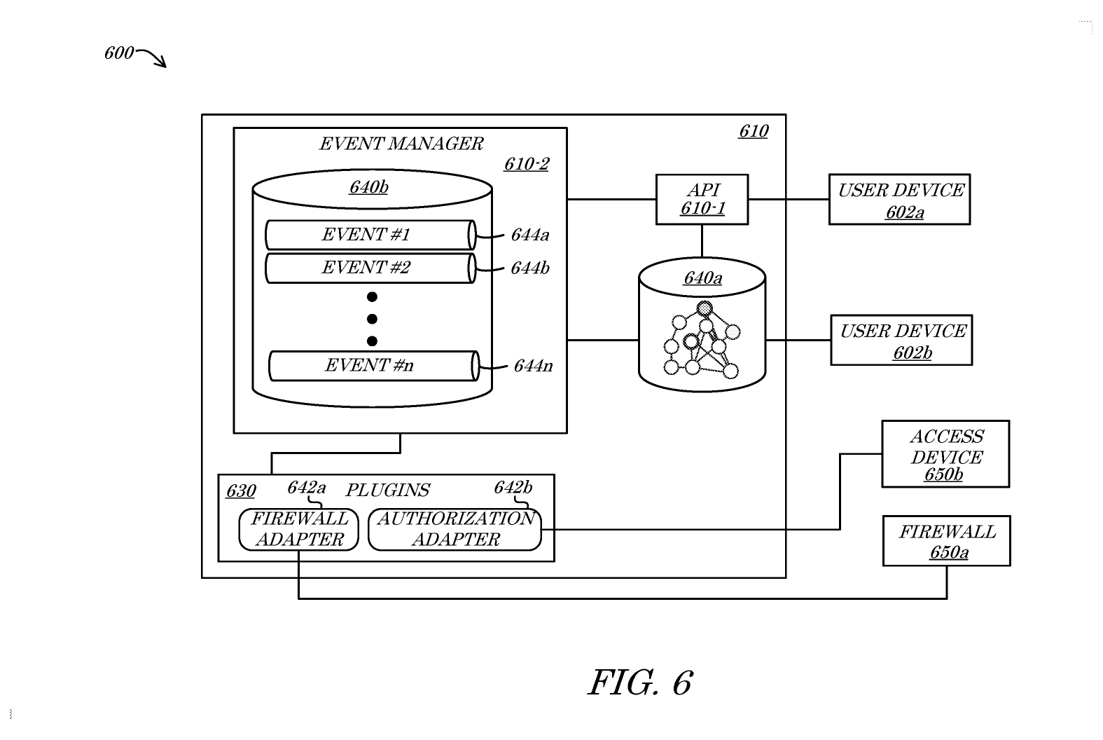

Referring now to FIG. 6, a block diagram of a system 600 according to some embodiments is shown. In some embodiments, the system 600 may comprise a portion of a GDB entitlement management system that enables one or more user devices 602a-b (and/or associated users; not separately shown) to undo or "replay" entitlement changes. The system 600 may comprise, for example, a GDB entitlement management controller 610 comprising and/or defining an API 610-1, an event manager 610-2, and/or a plurality of plugins 630. In some embodiments, the GDB entitlement management controller 610 may comprise and/or host a first database or GDB 640a and/or a second database or event store 640b. As depicted, the event store 640b may reside within and/or be accessible to and/or otherwise associated with the event manager 610-2. According to some embodiments, the API 610-1 may be utilized (e.g., by a first user device 602a) to implement one or more entitlement changes within the GDB 640a. As describe herein, such changes may create an event stream (not shown) within the GDB 640a and the event manager 610-2 may publish some or all of the events from the event stream, e.g., such that the published events are provided to the plugins 630.

According to some embodiments, and for purposes of non-limiting example, the plugins 630 may comprise and/or define a plurality of specially-programmed adapters 642a-b that are each responsive to particular published event data to effectuate changes in real-world settings. Continuing with an examplesimilar to that depicted in FIG. 5 herein, for example, the adapters 642a-b may include a first or firewall adapter 642a and/or a second or authorization adapter 642b. In some embodiments, actions executed by the adapters 642a-b may be stored as a series of executed event data 644a-n in the event store 640b, e.g., by the event manager 610-2. According to some embodiments, one or more of the events 644a-n may correspond to and/or be descriptive of the adapters 642a-b altering a real-world setting by sending a control signal to one or more real-world devices 650a-b. The firewall adapter 642a may control a first device or firewall 650a, for example, and/or the authorization adapter 642b may control a second or access device 650b.

In some embodiments, a user may desire that one or more entitlement changes be rolled back or undone. The change(s) may have been executed in error, for example, and/or may have not been performed correctly, e.g., due to a programming error in one or more of the adapters 642a-b. According to some embodiments, the user devices 602a-b may utilize the GDB entitlement management controller 610 to replay, undo, or roll back previously-executed entitlement changes (e.g., establishment, modification, and/or delete actions). The first user device 602a may communicate with the API 610-1 to request a replay/undo action, for example, and/or a second user device 602b may define a replay/undo request by directly interfacing with the GDB 640a. In some embodiments, the user devices 602a-b may identify one or more previous actions (previous requests, specific results, and/or times or time ranges) that are to be undone (or redone). In the case of the ongoing example of the firewall adapter 642a having changed a setting of the firewall 650a in response to a change in entitlement data stored in the GDB 640a, for example, the GDB entitlement management controller 610 (and/or the event manager 610-2 thereof) may identify all of the events 644a-n (GDB and/or non-GDB events) that are stored in relation to the previous action (e.g., from a set of all event data (not separately shown)). The data defining the events 644a-n may comprise data descriptive of the underlying events 644a-n as well as data defining relationships, such as hierarchy and/or timing, between the events 644a-n.

According to some embodiments, such as in the case that the corrective action is due to a bug in the firewall adapter 642a, the firewall adapter 642a may be fixed (e.g., in accordance with instructions, and/or new code, received from one or more of the user devices 602a-b). In some embodiments, changes to the specific events 644a-n may be received and/or implemented. In either case, once desired changes or corrections are made, the event manager 610-2 may publish (or republish) the identified events 644a- n. The publication may trigger appropriate responsive actions from one or more of the plugins 630. Revised/corrected code defining the firewall adapter 642a may be triggered by one or more of the events 644a-n, for example, and may send an updated/new control signal to the firewall 650a to, e.g., correct a real-world setting (e.g., firewall port setting) in accordance with the desired change(s) to the entitlement data stored in the GDB 640a.

Fewer or more components 602a-b, 610, 610-1, 610-2, 630, 640a-b, 642a-b, 644a-n, 650a-b and/orvarious configurations of the depicted components 602a-b, 610, 610-1, 610-2, 630, 640a-b, 642a- b, 644a-n, 650a-b may be included in the system 600 without deviating from the scope of embodiments described herein. In some embodiments, the components 602a-b, 610, 610-1, 610-2, 630, 640a-b, 642a- b, 644a-n, 650a-b may be similar in configuration and/or functionality to similarly named and/or numbered components as described herein. In some embodiments, the system 600 (and/or portions thereof) may comprise a GDB entitlement management program, system, and/or platform programmed and/or otherwise configured to execute, conduct, and/or facilitate the methods/algorithms 700, 800,1100 of FIG. 7, FIG. 8, and/or FIG. 11 herein, and/or portions or combinations thereof.

### III. GDB Entitlement Management Processes

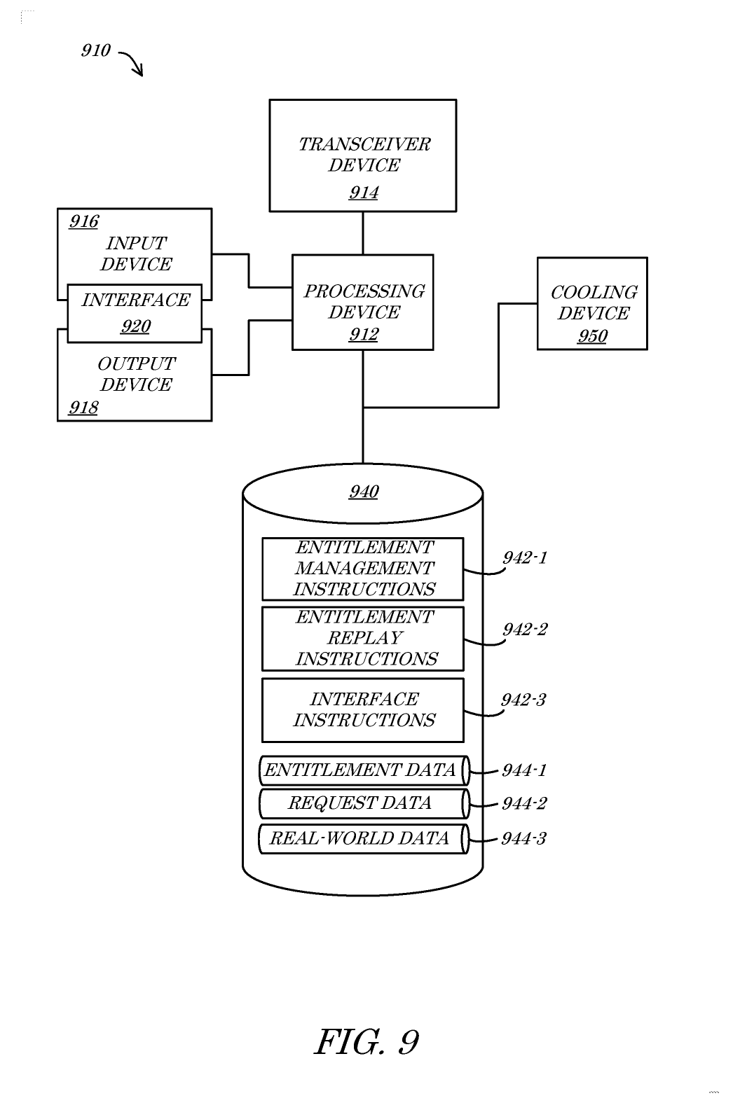

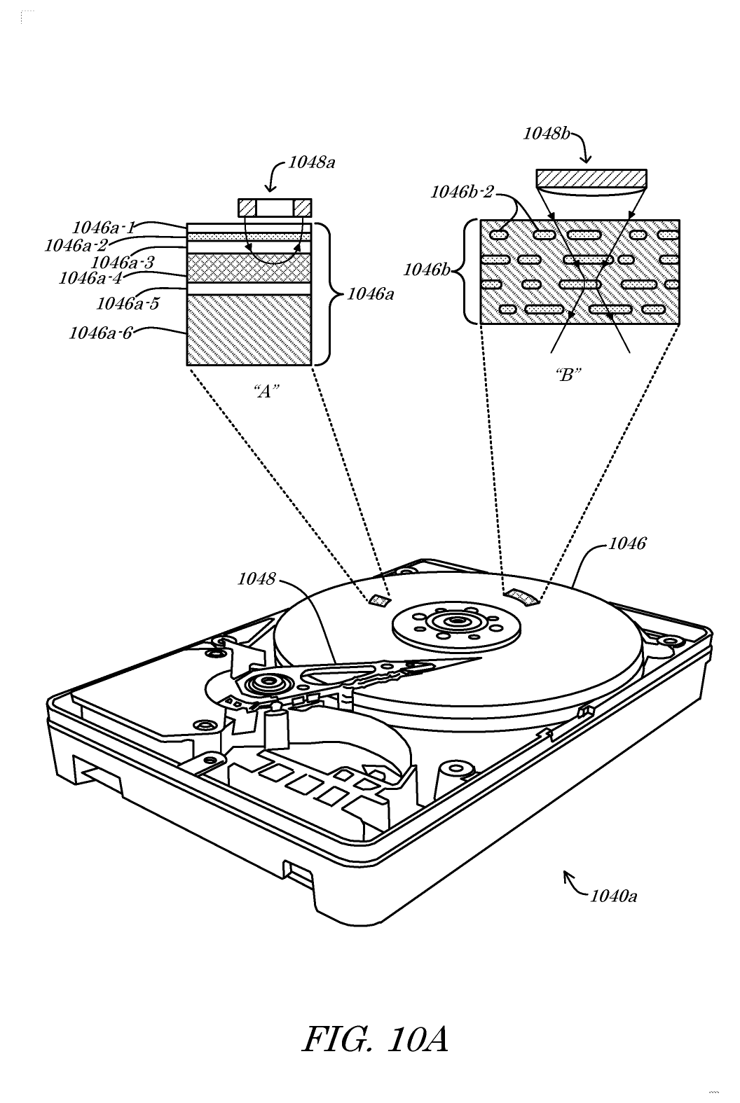

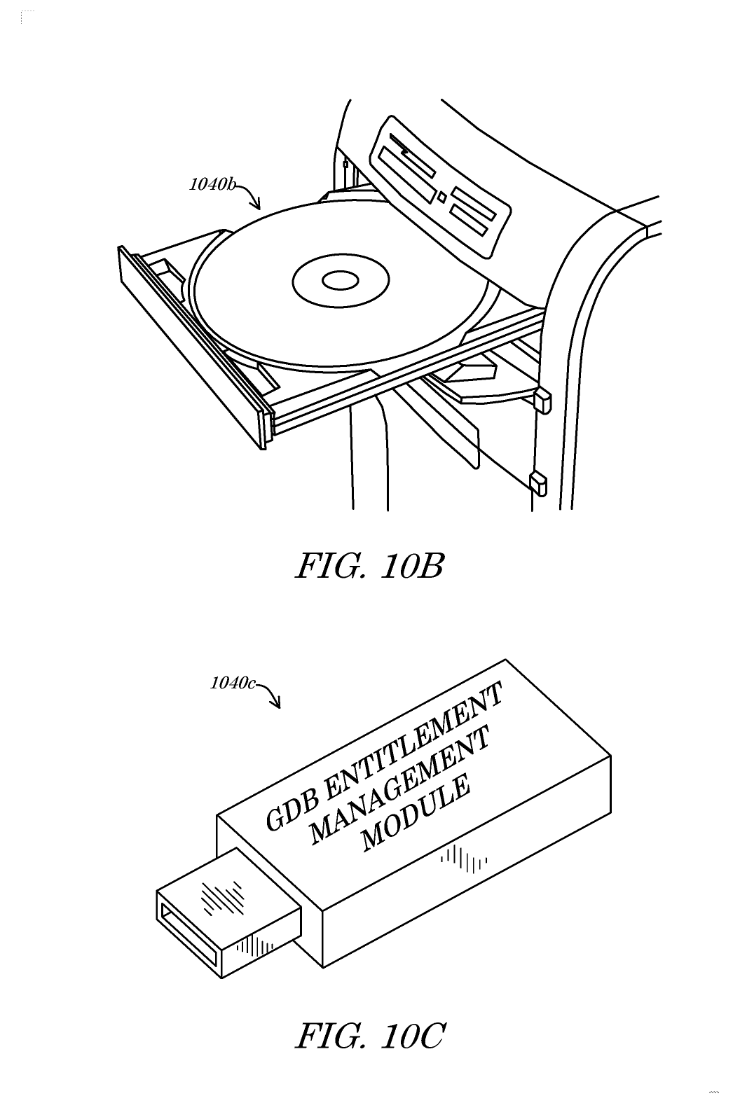

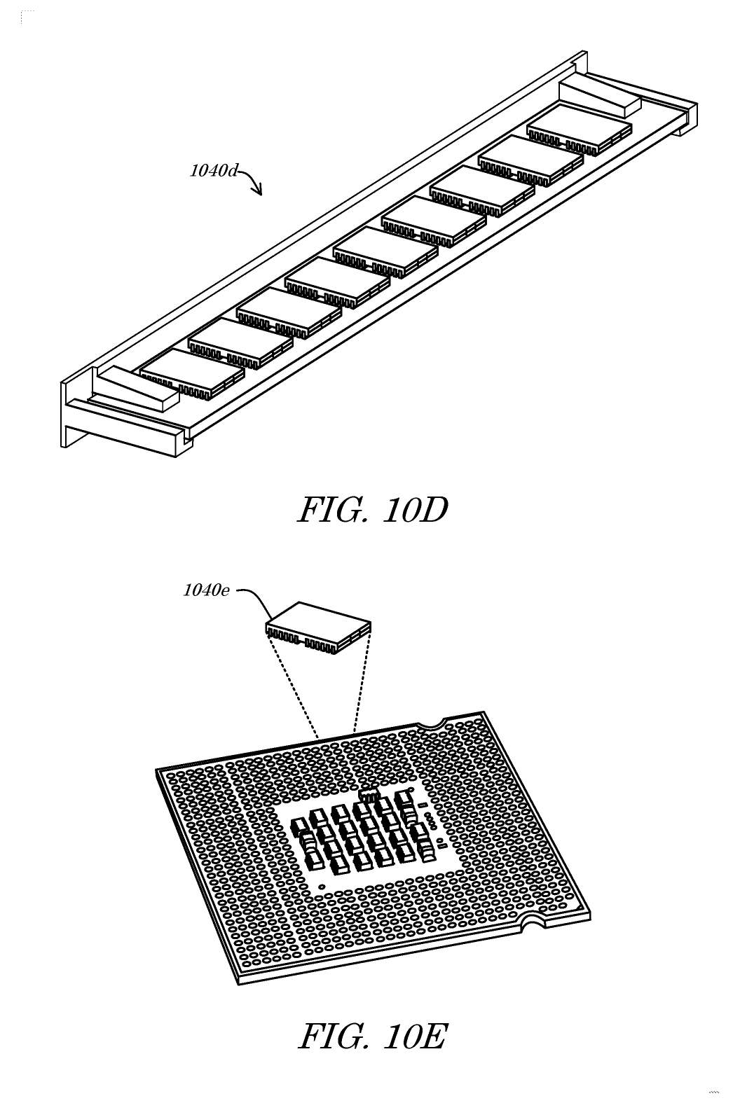

Referring now to FIG. 7, a flow diagram of a process or method 700 according to some embodiments is shown. In some embodiments, the method 700 may be performed and/or implemented by and/or otherwise associated with one or more specialized and/or specially-programmed computers (e.g., the user devices 102a-n, 402, 502a-b, 602a-b, third-party devices 106, 506, and/or entitlement management devices/apparatus 110, 410, 510a-f, 610, 910 of FIG. 1, FIG. 2, FIG. 4, FIG. 5, FIG. 6, and/or FIG. 9 herein), computer terminals, computer servers, computer systems and/or networks, and/or any combinations thereof (e.g., by one or more multi-threaded and/or multi-core processing units of a GDB entitlement management system). In some embodiments, the method 700 may be embodied in, facilitated by, and/or otherwise associated with various input mechanisms and/or interfaces (e.g., the interfaces 420, 520, 920, of FIG. 4, FIG. 5, and/or FIG. 9 herein). The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes, methods, and/or algorithms described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the memory devices 140, 208a-1, 240, 340,440, 540,640a-b, 940, 1040a-e, 1140 of FIG. 1, FIG. 2, FIG. 3, FIG. 4, FIG. 5, FIG. 6, FIG. 9, FIG. 10A, FIG. 10B, FIG. 10C, FIG. 10D, FIG. 10E, and/or FIG. 11 herein) may store thereon instructions that when executed by a machine (such as a computerized processor) result in performance according to any one or more of the embodiments described herein.

In some embodiments, the method 700 may comprise registering (e.g., by a processing device) resources in a GDB, at 702. Resources or assets of an IT system may comprise, for example, one or more physical (e.g., databases, memory devices, functions), logical (e.g., AD groups, identity groups and/or credentials, firewall rules), and/or identity (e.g., capabilities, users, devices, network components) resources, each of which may be registered in the GDB by creation of one or more data records therein. The resources may be described as an entitlement matrix, in some embodiments, as described with reference to the system 200 of FIG. 2 herein and/or the data storage structure 340 of FIG. 3 herein. According to some embodiments, an "entitlement" may be utilized to describe a relationship and/or interaction between two or more resources (e.g., nodes) in the system. As described herein, a plurality of nodes and relationships may be stored in the GDB in a graph format. The registration may comprise storing, with respect to each node and relationship, data descriptive of the node/relationship. In some embodiments, node data may comprise computer MAC address and/or IP address data or user credential data, for example, while relationship data may comprise data defining a type, hierarchy, sequence, temporal value (e.g., time window, start time, end time, and/or Time-To-Live (TTL)), etc. In some embodiments, the GDB into which the resources are registered may be referred to as an "entitlements store".

According to some embodiments, the method 700 may comprise outputting (e.g., by the processing device and/or by a user device) a GUI, at 704. The GUI may comprise, for example, various input and/or output mechanisms that represent the nodes and relationships registered at 702. In some embodiments, the GUI may comprise a graph analytics viewing tool as described in co-pending U.S. Patent Application No. 18/181132 filed on March 9, 2023 and titled "SYSTEMS AND METHODS FOR APPLICATION AND DATA DEPENDENCY IDENTIFICATION, VISUALIZATION, AND MANAGEMENT", the GDB viewing and GUI concepts and descriptions of which are hereby incorporated by reference herein. The GUI may be defined, generated, and/or output by a central system (e.g., a GDB entitlement management system and/or device) and/or communicated to a remote user device that outputs the GUI in response to data received from the central system. According to some embodiments, the GUI may be provided to and/or via a user device operated by a user, such that the user may view output via the GUI and may utilize the GUI to provide and/or define input to the system.

In some embodiments, the method 700 may comprise receiving (e.g., by the processing device and/or from the user device) a request, at 706. The user may utilize the GUI, for example, to identify one or more resources and/or entitlements that are selected for various purposes, such as viewing, establishment or creation, editing or modification, and/or deletion, deactivation, and/or removal. According to some embodiments, the request (e.g., such as the request 402-1 of FIG. 4 herein) maycomprise data identifying one or more nodes and/or relationships stored in the GDB. In some embodiments, the request may comprise a query structured in accordance with a particular query language, such as a declarative graph query language (e.g., Cypher^{T}M, available from Neo4j@, Inc. of San Mateo, CA).

According to some embodiments, the method 700 may comprise submitting (e.g., by the processing device and/or to a GDB) the request, at 708. The system may forward the request (e.g., if pre-formatted in an appropriate graph query language) directly to the GDB, for example, or may process (e.g., analyze and/or format) the request prior to submitting to the GDB. In either case, the GDB may receive the request or data indicative thereof, that identifies one or more data acquisition and/or change requests for the identified (e.g., a subset of the total) nodes and/or relationships stored in the GDB. According to some embodiments, the GDB may process the request/query by identifying, providing, and/or modifying stored data elements. Such transactions within the GDB may generate a change stream and/or event stream in accordance with the settings of the GDB instance.

In some embodiments, the method 700 may comprise identifying (e.g., by the processing device) a GDB event, at 710. The system may listen to the change/event stream of the GDB, for example, and identify one or more GDB events. According to some embodiments, only those GDB events (e.g., a subset of GDB events) that meet certain predefined criteria may be identified and/or selected. GDB events descriptive of data viewing activities may not be necessary in some embodiments, for example, and may accordingly not be identified and/or selected, while GDB events descriptive of changes to data stored in the GDB may be identified and/or selected.

According to some embodiments, the method 700 may comprise publishing (e.g., by the processing device) the GDB event, at 712. The system may publish any or all identified/selected GDB events outside of the GDB instance, for example, to provide the selected GDB event data to components of the system that are not resident within the GDB instance. In some embodiments, the publication may comprise an active transmission (e.g., a "push") of event data through and/or via an event bus and/or to one or more specific system components. According to some embodiments, the publication may comprise an updating of an event listing, store, and/or record that is available for access to system components (e.g., available via "pull" actions).

In some embodiments, the method 700 may comprise listening (e.g., by the processing device and/or by a suite of plugin adapters) for GDB events, at 714. One or more plugin adapters of the system may listen for broadcast GDB event publication data, for example, and/or may query and/or interrogate an event store, e.g., populated and/or updated at 712. According to some embodiments, the method 700 (and/or the listening, at 714) may comprise identifying (e.g., by the processing device and/or a particular plugin adapter) the GDB event, at 714-1. Each plugin adapter may be specially-programmed to listen for certain types of GDB events, events during certain timeframes (e.g., times of day), etc., for example, and may identify GDB (and/or other) events in accordance with one or more identification parameters. According to some embodiments, all published events (GDB or otherwise) may be identified by a particular plugin adapter.

In some embodiments, the method 700 (and/or the listening, at 714) may comprise determining (e.g., by the processing device and/or the particular plugin adapter) whether the GDB event satisfies stored criteria, at 714-2. GDB event data may be compared to specially-programmed criteria and/or thresholds for each respective plugin adapter, for example, such that any particular plugin adapter may identify a subset of the published GDB events that are relevant to the specially-programmed functionality of the plugin adapter. To continue with the ongoing, non-limiting example of a request that requires a firewall setting to be changed, for example, a particular plugin adapter specially-programmed to change and/or control firewall settings may listen for and identify GDB events that include data identifying one or more firewall devices and/or settings. In a case where the identified GDB event does not satisfy stored criteria, the method 700 may loop back to and/or continue by identifying a new/different GDB event, at 714-1.

According to some embodiments, such as in a case where the GDB event does satisfy stored criteria, the method 700 (and/or the listening, at 714) may comprise transforming (e.g., by the processing device and/or the particular plugin adapter) a system setting, at 714-3. Each plugin adapter may be specially-programmed to map a specific entitlement change to a corresponding change (e.g., transformation) of a "real-world" setting. As utilized herein, the term "real-world" generally refers to settings, configurations, and/or activities of physical devices (such as routers, firewalls, computers, etc.) and may generally be utilized to distinguish stored representations of such settings/configurations/activities. Data describing a status of a particular firewall port as being "open" that is stored in the GDB, for example, may be intended to reflect an actual current setting of the port, but may not be synchronized with or correspond to the "real-world" or actual setting of the firewall port, for various reasons related to operations of the IT infrastructure. The transforming at 714-3 accordingly refers to the change in the actual "real-world" of physical-world setting of the, e.g., firewall port. According to some embodiments, a transformation may comprise an establishment of access permission structures, modifying network rules and/or settings, and/or changing load-balance configurations, all with respect to various network components associated therewith.

In some embodiments, specially-coded transformations implemented for any specific GDB event (or set of GDB events) may by capable of being implemented immediately or in real-time, such as the example of the firewall port setting change (e.g., a "declarative entitlement"). According to some embodiments, certain transformations, such as deploying a stored procedure/code, may require time to transform and/or establish (e.g., "procedural entitlements"). Procedural entitlements may take minutes, hours, or even days to finalize. In some embodiments, procedural entitlements may be tagged or marked as "pending" until finalized and/or may be governed by a stored TTL, such as a one-hour TTL pendency window. In some embodiments, an entitlement may be designed to be temporary or otherwise subject to existence with respect to one or more time-based rules (e.g., a "dynamic entitlement"; e.g., dynamically- generated access credentials). In the case of dynamic entitlements, they may be tagged and/or marked with "active" or "inactive" (or "dormant") to signify that their transformative effects are currently being deployed or are awaiting deployment, as the case may be.

According to some embodiments, once a system setting triggered by a particular GDB event has been transformed, the method 700 (and/or the listening, at 714) may loop back to and/or continue by identifying a new/different GDB event, at 714-1. In some embodiments, the listening at 714 may continue on a constant and/or scheduled basis, such that one or more plugin adapters are always listening, during their active lives, for relevant GDB (and/or other) events.

In some embodiments, the system may access and/or query third-party data to obtain permissions for certain transformations and/or may automatically (e.g., periodically) cull pending entitlement changes that have exceeded their TTL parameters. According to some embodiments, the system may operate to validate relationships/entitlements on a periodic and/or recurring basis. The system may automatically, for example, query GDB and/or corresponding real-world data to produce and publish a compacted view of the current state of all relationships. In some embodiments, the publication may be specially-tagged, such as with the term "validation mode", to cause any listening plugin adapters to process the published event data in a special (e.g., second) mode. Instead of inputting the event data and implementing a transformation, for example, a plugin adapter operating in "validation mode" may verify relationship data correspondence/matching, identify and/or report anomalies (e.g., match failures), and/or automatically attempt to "heal" or fix a mismatched or "broken" relationship. According to some embodiments, a plugin adapter may operate in one of a plurality of specially-programmed modes, such as: (i) an execution mode (e.g., in which GDB events trigger transformation of real-world settings), (ii) a validation mode (e.g., in which existing relationships/entitlements are checked and/or healed), (iii) an expire mode (e.g., in which the plugin adapter removes a particular relationships/entitlements and reports the removal thereof), and/or (iv) an overdue mode (e.g., in which any pending relationships/entitlements that have exceeded TTL parameters are logged, reported, and/or automatically consummated).

While many specific actions of the method 700 have been described with respect to FIG. 7, fewer or more actions, transmissions, and/or processing procedures (e.g., code and/or LLM instance executions) may be implemented in the method 700 without deviating from embodiments herein. According to some embodiments, any transmission sent from an origin to a destination may be received by and/or at the destination, e.g., in response to the transmission. In some embodiments, fewer or more components and/or various configurations of the described components may be included in the method 700 without deviating from the scope of embodiments described herein. In some embodiments, the described components may be similar in configuration and/or functionality to similarly named and/or numbered components as described herein.

Referring now to FIG. 8, a flow diagram of a process or method 800 according to some embodiments is shown. In some embodiments, the method 800 may be performed and/or implemented by and/or otherwise associated with one or more specialized and/or specially-programmed computers (e.g., the user devices 102a-n, 402, 502a-b, 602a-b, third-party devices 106, 506, and/or entitlement management devices/apparatus 110, 410, 510a-f,610, 910 of FIG. 1, FIG. 2, FIG. 4, FIG. 5, FIG. 6, and/or FIG. 9 herein), computer terminals, computer servers, computer systems and/or networks, and/or any combinations thereof (e.g., by one or more multi-threaded and/or multi-core processing units of a GDB entitlement management system). In some embodiments, the method 800 may be embodied in, facilitated by, and/or otherwise associated with various input mechanisms and/or interfaces (e.g., the interfaces 420, 520, 920, of FIG. 4, FIG. 5, and/or FIG. 9 herein). In some embodiments, the method 800 may comprise a method for undoing, replaying, and/or rolling back one or more entitlement changes implemented by an execution of the method 700 of FIG. 7 herein.

In some embodiments, the method 800 may comprise receiving (e.g., by a processing device) a request to fix a change, at 802. Change request data may be received from a user device and/or via a GUI (e.g., the GUI provided/output at 704 of the method 700 of FIG. 7 herein), for example, and/or may identify one or more previous entitlement, node, relationship, and/or other IT infrastructure GDB changes that are selected for modification, undoing, replay, rollback, etc. According to some embodiments, the change request may identify and/or define a broken adapter that needs to be repaired. The request may comprise, for example, an indication of a request change to specific lines of code defining a specially- programmed adapter (e.g., an adapter 442a-n, 542c-d, 642a-b of FIG. 4, FIG. 5, and/or FIG. 6 herein) or a request to substitute a program, code snippet, algorithm, module, etc., with a new/update version.

According to some embodiments, the method 800 may comprise fixing (e.g., by the processing device and/or by a user device) the broken plugin adapter, at 804. Utilizing the information provided by the change request, for example, the system may repair, recode, recompile, replace, and/or otherwise fix the identified adapter. In embodiments where the change request requests a change that is not associated with a broken adapter, the fixing may not be required. According to some embodiments, the system may utilize information in the change request to identify a broken adapter and automatically repair it, e.g., without the user having identified the adapter as the reason for the undo/rollback. The system may analyze change request data to identify the committed change, the desired change (whether desired currently or at the time of the original change), and/or which adapters processed the change. In such a manner, for example, the system may find an error in the adapter based on the differences between the change that the adapter committed with respect to the change that the user requested/desired.

In some embodiments, the method 800 may comprise identifying (e.g., by the processing device) GDB (and/or non-GDB) events, at 806. Stored event data may be queried, for example, to identify events that occurred in the timeframe (e.g., a predetermined threshold of time before and/or after) of the original change. Whether pre-filtered based on time stamp or not, the method 800 (and/or the identifying, at 806) may comprise identifying (e.g., by the processing device and/or an event manager) a GDB event, at 806- 1. In some embodiments, the system may return a listing of events and may step through analyzing/filtering the events in a particular order (e.g., sequentially, round-robin, random). In some embodiments, the method 800 (and/or the identifying, at 806) may comprise determining (e.g., by the processing device and/or the event manager) whether the GDB event is related to the change, at 806-2. The change request data may be utilized, for example, to search for, query, and/or identify any or all events (GDB and/or non-GDB) that have been stored in association with the identified nodes, relationships, and/or entitlements for which the undo/replay action is requested.

In a case where data descriptive of the event does not match data corresponding to the change event parameters (e.g., does not match the node, relationship, entitlement, real-world setting, etc., that was originally changed), the method 800 (and/or the identifying, at 806) may comprise determining (e.g., by the processing device and/or the event manager) whether there are more GDB events, at 806-3. The listing of available/known events may be consulted, for example, to identify any events for which the determination (at 806-2) has not yet been made. In the case that one or more events remain to be analyzed, the method 800 (and/or the identifying, at 806) may loop back to and/or continue by identifying a new/different GDB event, at 806-1.

In a case where data descriptive of the event matches data corresponding to the change event parameters (e.g., matches the node, relationship, entitlement, real-world setting, etc., that was originally changed), the method 800 (and/or the identifying, at 806) may comprise storing (e.g., by the processing device and/or the event manager) GDB event data, at 806-4. The analyzed event may be determined to be relevant to the original change that is desired to be undone/replayed, for example, and may accordingly be added to a replay, republication, and/or undo queue or listing. In some embodiments, once the processing/storing for a particular event is complete, the method 800 (and/or the identifying, at 806) may comprise and/or continue to the determining (e.g., by the processing device and/or the event manager) of whether there are more GDB events, at 806-3.

According to some embodiments, once all events (or all relevant events) have been processed and/or analyzed at 806, the method 800 may comprise and/or continue to republishing (e.g., by theprocessing device and/or the event manager) the stored GDB events, at 808. Any events (GDB and/or non-GDB) identified at 806 as being relevant to the original change and accordingly stored in the replay queue may, for example, be republished by the system. According to some embodiments, any or all adapters in the system may be provided with and/or have access to (e.g., subscribe to) the republished events, including any fixed adapter, e.g., from 804.

In some embodiments, the method 800 may comprise listening (e.g., by the processing device and/or by a suite of plugin adapters) for GDB events, at 810. One or more plugin adapters of the system may listen for broadcast GDB event publication data, for example, and/or may query and/or interrogate an event store containing published event data. According to some embodiments, the method 800 (and/or the listening, at 810) may comprise identifying (e.g., by the processing device and/or a particular plugin adapter) the GDB event, at 810-1. Each plugin adapter may be specially-programmed to listen for certain types of GDB events, events during certain timeframes (e.g., times of day), etc., for example, and may identify GDB (and/or other) events in accordance with one or more identification parameters. According to some embodiments, all published events (GDB or otherwise) may be identified by a particular plugin adapter.

In some embodiments, the method 800 (and/or the listening, at 810) may comprise determining (e.g., by the processing device and/or the particular plugin adapter) whether the GDB event satisfies stored criteria, at 810-2. GDB event data may be compared to specially-programmed criteria and/or thresholds for each respective plugin adapter, for example, such that any particular plugin adapter may identify a subset of the published GDB events that are relevant to the specially-programmed functionality of the plugin adapter. In a case where the identified GDB event does not satisfy stored criteria, the method 800 may loop back to and/or continue by identifying a new/different GDB event, at 810-1. As the republication is specifically-structured and/or targeted to events associated with a particular previous change to the GDB data stored by the system, in many cases the set of adapters that handled the events the first time they were published is likely to be the same set of adapters that handle the republished events.

According to some embodiments, such as in a case where the GDB event does satisfy stored criteria, the method 800 (and/or the listening, at 810) may comprise transforming (e.g., by the processing device and/or the particular plugin adapter) a system setting, at 810-3. Each plugin adapter may be specially-programmed to map a specific entitlement change to a corresponding change (e.g., transformation) of a "real-world" setting. In the case of a fixed/updated adapter, the transformation may occur in a manner different than originally performed for the particular event, e.g., to correct the problem identified by the change request. In some embodiments, the transforming with respect to the events republished from the replay queue may cause a reversal of the original change. Any or all effects of the original change may be rolled back, removed, or undone, for example. As changes can be complex and can involve not only a large number of nodes and relationships but require a specific hierarchy, order, and/or timing of events, the rollback utilizing the replay queue may provide not only an automated solution for fixing undesirable entitlement changes, but may also not be possible without the specially- programmed systems, components, and/or methods described herein.

According to some embodiments, once a system setting triggered by a particular GDB event has been transformed (or retransformed), the method 800 (and/or the listening, at 810) may loop back to and/or continue by identifying a new/different GDB event, at 810-1. In some embodiments, the listening at 810 may continue on a constant and/or scheduled basis, such that one or more plugin adapters are always listening, during their active lives, for relevant GDB (and/or other) events. According to some embodiments, the method 800 may alternatively cycle through the events in the replay queue and then cease execution.

While many specific actions of the method 800 have been described with respect to FIG. 8, fewer or more actions, transmissions, and/or processing procedures (e.g., code and/or LLM instance executions) may be implemented in the method 800 without deviating from embodiments herein. According to some embodiments, any transmission sent from an origin to a destination may be received by and/or at the destination, e.g., in response to the transmission. In some embodiments, fewer or more components and/or various configurations of the described components may be included in the method 800 without deviating from the scope of embodiments described herein. In some embodiments, the described components may be similar in configuration and/or functionality to similarly named and/or numbered components as described herein.

### IV. GDB Entitlement Management Apparatus, Articles of Manufacture, and Algorithms

Turning to FIG. 9, a block diagram of an apparatus 910 according to some embodiments is shown. In some embodiments, the apparatus 910 may be similar in configuration and/or functionality to any of the user devices 102a-n, 402, 502a-b, 602a-b, third-party devices 106, 506, and/or entitlement management devices/apparatus 110, 410, 510a-f, 610, 910 of FIG. 1, FIG. 2, FIG. 4, FIG. 5, FIG. 6, and/or FIG. 9 herein. The apparatus 910 may, for example, execute, process, facilitate, and/or otherwise be associated with the methods/algorithms 700, 800,1100 of FIG. 7, FIG. 8, and/or FIG. 11 herein, and/or portions or combinations thereof. In some embodiments, the apparatus 910 may comprise a processing device 912 (e.g., a processor), a transceiver device 914, an input device 916, an output device 918, an interface 920, a memory device 940 (storing various programs and/or instructions 942 and data 944), and/or a cooling device 950. According to some embodiments, any or all of the components 912, 914, 916, 918, 920, 940, 942, 944, 950 of the apparatus 910 may be similar in configuration and/or functionality to any similarly named and/or numbered components described herein. Fewer or more components 912,914, 916, 918, 920,940, 942, 944, 950 and/or various configurations of the components 912, 914, 916, 918, 920, 940, 942, 944, 950 may be included in the apparatus 910 without deviating from the scope of embodiments described herein.

According to some embodiments, the processor 912 may be or include any type, quantity, and/or configuration of processor that is or becomes known. The processor 912 may comprise, for example, an Intel@IXP 2800 network processor or an Intel@XEON TM Processor coupled with an Intel@E8901 chipset. In some embodiments, the processor 912 may comprise multiple inter-connected processors (e.g., a processing array), microprocessors (e.g., one or more GPU devices), and/or micro-engines. According to some embodiments, the processor 912 (and/or the apparatus 910 and/or other components thereof) may be supplied power via a power supply (not shown), such as a battery, an Alternating Current (AC) source, a Direct Current (DC) source, an AC/DC adapter, solar cells, and/or an inertial generator. In the case that the apparatus 910 comprises a server, such as a blade server, necessary power may be supplied via a standard AC outlet, power strip, surge protector, and/or Uninterruptible Power Supply (UPS) device.

In some embodiments, the transceiver device 914 may comprise any type or configuration of communication device that is or becomes known or practicable. The transceiver device 914 may, for example, comprise a Network Interface Card (NIC), a telephonic device, a cellular network device, a router, a hub, a modem, and/or a communications port or cable. According to some embodiments, the transceiver device 914 may also or alternatively be coupled to the processor 912. In some embodiments, the transceiver device 914 may comprise an IR, RF, Bluetooth^{T}M, Near-Field Communication (NFC), and/or Wi-Fi@ network device coupled to facilitate communications between the processor 912 and another device (not shown).

According to some embodiments, the input device 916 and/or the output device 918 are communicatively coupled to the processor 912 (e.g., via wired and/or wireless connections and/or pathways) and they may generally comprise any types or configurations of input and output components and/or devices that are or become known, respectively. The input device 916 may comprise, for example, a keyboard that allows an operator of the apparatus 910 to interface with the apparatus 910 (e.g., by a programmer and/or user establishing, modifying, and/or deleting entitlement data for an IT system, as described herein). The output device 918 may, according to some embodiments, comprise a display screen and/or other practicable output component and/or device. The output device 918 may, for example, provide an interface 920 (such as the interfaces 420, 520, of FIG. 4 and/or FIG. 5 herein) via which a user may request and/or manage entitlements. According to some embodiments, the input device 916 and/or the output device 918 may comprise and/or be embodied in a single device, such as a touch- screen monitor.

The memory device 940 may comprise any appropriate information storage device that is or becomes known or available, including, but not limited to, units and/or combinations of magnetic storage devices (e.g., a hard disk drive), optical storage devices, and/or semiconductor memory devices, such as RAM devices, Read Only Memory (ROM) devices, Single Data Rate Random Access Memory (SDR- RAM), Double Data Rate Random Access Memory (DDR-RAM), and/or Programmable Read Only Memory (PROM). The memory device 940 may, according to some embodiments, store one or more of entitlement management instructions 942-1, entitlement replay instructions 942-2, interface instructions 942-3, entitlement data 944-1, request data 944-2, and/or real-world data 944-3. In some embodiments, the entitlement management instructions 942-1, entitlement replay instructions 942-2, interface instructions 942-3, entitlement data 944-1, request data 944-2, and/or real-world data 944-3 may be utilized by the processor 912 to provide output information via the output device 918 and/or the transceiver device 914.

According to some embodiments, the entitlement management instructions 942-1 may be operable to cause the processor 912 to process the entitlement data 944-1, request data 944-2, and/or real-world data 944-3 in accordance with embodiments as described herein. Entitlement data 944-1, request data 944-2, and/or real-world data 944-3 received via the input device 916 and/or the transceiver device 914 may, for example, be analyzed, sorted, filtered, decoded, decompressed, ranked, scored, plotted, and/or otherwise processed by the processor 912 in accordance with the entitlement management instructions 942-1. In some embodiments, entitlement data 944-1, request data 944-2, and/or real-world data 944-3 may be fed by the processor 912 through one or more mathematical and/or statistical formulas and/or models in accordance with the entitlement management instructions 942-1 to implement a coordinated and automatic change in GDB-stored entitlement data and real-world device settings, as described herein.

In some embodiments, the entitlement replay instructions 942-2 may be operable to cause the processor 912 to process the entitlement data 944-1, request data 944-2, and/or real-world data 944-3 in accordance with embodiments as described herein. Entitlement data 944-1, request data 944-2, and/or real-world data 944-3 received via the input device 916 and/or the transceiver device 914 may, for example, be analyzed, sorted, filtered, decoded, decompressed, ranked, scored, plotted, and/or otherwise processed by the processor 912 in accordance with the entitlement replay instructions 942-2. In some embodiments, entitlement data 944-1, request data 944-2, and/or real-world data 944-3 may be fed by the processor 912 through one or more mathematical and/or statistical formulas and/or models in accordance with the entitlement replay instructions 942-2 to replay or undo a previous entitlement change in a GDB-based entitlement management system, as described herein.

According to some embodiments, the interface instructions 942-3 may be operable to cause the processor 912 to process the entitlement data 944-1, request data 944-2, and/or real-world data 944-3 in accordance with embodiments as described herein. Entitlement data 944-1, request data 944-2, and/or real-world data 944-3 received via the input device 916 and/or the transceiver device 914 may, for example, be analyzed, sorted, filtered, decoded, decompressed, ranked, scored, plotted, and/or otherwise processed by the processor 912 in accordance with the interface instructions 942-3. In some embodiments, entitlement data 944-1, request data 944-2, and/or real-world data 944-3 may be fed by the processor 912 through one or more mathematical and/or statistical formulas and/or models in accordance with the interface instructions 942-3 to generate, define, and/or output one or more GDB- based and/or GUI interfaces to implement GDB entitlement management system, as described herein. According to some embodiments, the apparatus 910 may comprise the cooling device 950. According to some embodiments, the cooling device 950 may be coupled (physically, thermally, and/or electrically) to the processor 912 and/or to the memory device 940. The cooling device 950 may, for example, comprise a fan, heat sink, heat pipe, radiator, cold plate, and/or other cooling component or device or combinations thereof, configured to remove heat from portions or components of the apparatus 910.

Any or all of the exemplary instructions and data types described herein and other practicable types of data may be stored in any number, type, and/or configuration of memory devices that is or becomes known. The memory device 940 may, for example, comprise one or more data tables or files, databases, table spaces, registers, and/or other storage structures. In some embodiments, multiple databases and/or storage structures (and/or multiple memory devices 940) may be utilized to store information associated with the apparatus 910. According to some embodiments, the memory device 940 may be incorporated into and/or otherwise coupled to the apparatus 910 (e.g., as shown) or may simply be accessible to the apparatus 910 (e.g., externally located and/or situated).

Referring to FIG. 10A, FIG. 10B, FIG. 10C, FIG. 10D, and FIG. 10E, perspective diagrams of exemplary data storage devices 1040a-e according to some embodiments are shown. The data storage devices 1040a-e may, for example, be utilized to store instructions and/or data, such as the entitlement management instructions 942-1, entitlement replay instructions 942-2, interface instructions 942-3, entitlement data 944-1, request data 944-2, and/or real-world data 944-3, each of which is presented in reference to FIG. 9 herein. In some embodiments, instructions stored on the data storage devices 1040a- e may, when executed by a processor, cause the implementation of and/or facilitate the methods/algorithms 700, 800, 1100 of FIG. 7, FIG. 8, and/or FIG. 11 herein, and/or portions or combinations thereof.

According to some embodiments, the first data storage device 1040a may comprise one or more various types of internal and/or external hard drives. The first data storage device 1040a may, for example, comprise a data storage medium 1046 that is read, interrogated, and/or otherwise communicatively coupled to and/or via a disk reading device 1048. In some embodiments, the first data storage device 1040a and/or the data storage medium 1046 may be configured to store information utilizing one or more magnetic, inductive, and/or optical means (e.g., magnetic, inductive, and/or optical- encoding). The data storage medium 1046, depicted as a first data storage medium 1046a for example (e.g., breakout cross-section "A"), may comprise one or more of a polymer layer 1046a-1, a magnetic data storage layer 1046a-2, a non-magnetic layer 1046a-3, a magnetic base layer 1046a-4, a contact layer 1046a-5, and/or a substrate layer 1046a-6. According to some embodiments, a magnetic read head 1048a may be coupled and/or disposed to read data from the magnetic data storage layer 1046a-2.

In some embodiments, the data storage medium 1046, depicted as a second data storage medium 1046b for example (e.g., breakout cross-section "B"), may comprise a plurality of data points 1046b-2 disposed with the second data storage medium 1046b. The data points 1046b-2 may, in some embodiments, be read and/or otherwise interfaced with via a laser-enabled read head 1048b disposed and/or coupled to direct a laser beam through the second data storage medium 1046b.

In some embodiments, the second data storage device 1040b may comprise a CD, CD-ROM, DVD, Blu-Ray TM Disc, and/or other type of optically-encoded disk and/or other storage medium that is or becomes know or practicable. In some embodiments, the third data storage device 1040c may comprise a USB keyfob, dongle, and/or other type of flash or solid-state memory or data storage device that is or becomes know or practicable. In some embodiments, the fourth data storage device 1040d may comprise RAM of any type, quantity, and/or configuration that is or becomes practicable and/or desirable. In some embodiments, the fourth data storage device 1040d may comprise an off-chip cache, such as a Level 2 (L2) cache memory device. According to some embodiments, the fifth data storage device 1040e may comprise an on-chip memory device, such as a Level 1 (L1) cache memory device.

The data storage devices 1040a-e may generally store program instructions, code, and/or modules that, when executed by a processing device cause a particular machine to function in accordance with one or more embodiments described herein. The data storage devices 1040a-e depicted in FIG. 10A, FIG. 10B, FIG. 10C, FIG. 10D, and FIG. 10E are representative of a class and/or subset of computer-readable media that are defined herein as "computer-readable memory" (e.g., non-transitory memory devices as opposed to transmission devices or media).

With reference to FIG. 11, for example, the data storage devices 1040a-e may store and/or define an algorithm 1100. The algorithm 1100 may comprise, for example, one or more software programs, modules, engines, models (e.g., Al models), and/or applications coded to perform the methods 700, 800 of FIG. 7 and/or FIG. 8 herein, and/or portions or combinations thereof. The algorithm 1100, and any reference to the term "algorithm" herein, refers to any set of defined instructions and/or trained instruction, guidelines, and/or prompt sets that operate upon input to define and/or provide output. The algorithm 1100 may, for example, be specifically programmed, trained, and/or otherwise defined to instruct a computer or other device (not shown) to solve a particular problem (e.g., logical) and/or resolve a particular mathematical calculation (e.g., arithmetic). In some embodiments, the algorithm 1100 may be written and/or defined as a series or sequence of instructions, guidelines, formulas, thresholds, rules, and/or prompts encoded in (e.g., written in accordance with syntax and/or semantics rules) a particular computer programming language (e.g., Python^{T}M, JavaTM, JavaScriptTM, C, C++, C#, Basic^{T}M, FORTRAN, COBOL, Ruby^{T}M, and/or PerTM), e.g., a set of instructions that convert and/or encode characters, objects, and/or other data elements into machine code (e.g., code operable to be executed by an electronic processing device, such as a CPU).

According to some embodiments, the algorithm 1100 may comprise soliciting input, at 1102. Input from one or more sources may be searched for and/or queried, by structuring and/or executing a database query and/or by sending a data communication signal or "handshake", such as is common with Bluetooth@ short-range communication protocols. In some embodiments, the algorithm 1100 may comprise receiving the input, at 1104. Whether solicited or otherwise provided and/or acquired (e.g., loaded and/or downloaded), for example, the input for the algorithm 1100 may be received, identified, and/or otherwise processed and/or located. According to some embodiments, the algorithm 1100 may comprise data processing, at 1112. The data processing 1112 may, for example, comprise execution of one or more logical and/or computational procedures, modules, scripts, models, and/or routines that may be stored in a memory device 1140 (e.g., similar to the data storage devices 1040a-e) as a set of instructions or rules 1142 and/or that may be defined and/or implemented by one or more electrical, mechanical, and/or physical components, such as logic gates, diodes, transistors, relays, and/or switches (e.g., operable to execute the methods 700, 800 of FIG. 7 and/or FIG. 8 herein, and/or portions or combinations thereof).

In some embodiments, execution of the algorithm 1100 may comprise a loading of the rules 1142 into the memory device 1140 and/or into an electronic processing system (not shown) and/or an activation of one or more logic gates and/or other electrical and/or mechanical components. The algorithm 1100 may operate upon the input in accordance with the rules 1142 to achieve a result by defining output, at 1118. The algorithm 1100 may, for example, generate, produce, define, identify, calculate, and/or otherwise compute output based on an application of the data processing 1112 utilizing the rules 1142 and any or all input receiving at 1104. According to some embodiments, the algorithm 1100 may comprise providing the output, at 1120. One or more output devices (not shown) may be utilized to convey the output (e.g., a result, conclusion, decision, etc.) to one or more other devices and/or entities (not shown), such as one or more users, consumers, customers, potential customers, and/or devices utilized thereby. The output may be displayed via an electronic display screen of a computer, mobile/smart phone, smart watch, etc., and/or may be transmitted as one or more electronic signals to one or more network destination addresses, such as email addresses, URL locations, MAC addresses, and/or broadcast radio frequencies.

According to some embodiments, the data processing at 1112 may comprise execution of a listing, sequence, matrix, and/or other set of stored steps and/or instructions that utilize the input to define the output. In some embodiments, the listing of steps and/or instruction details may comprise elements that are known to those skilled in the art. The algorithm 1100 may partially or completely comprise, for example, instructions and/or steps that are well known, such as steps and/or instructions operable to calculate an area (length times width), volume (length times width times height), distance (difference between two locations), velocity (distance over time), acceleration (velocity over time), and/or any other known mathematical and/or logical (if/then statements) procedures. For any and all known procedures and/or instructions, the discrete details of such instructions are represented by the data processing at 1112 and are not listed herein as one of ordinary skill in the art would readily comprehend both what such technological knowledge entails and that the inventor has possession of such knowledge. Instructions that may be included within and/or comprise the data processing at 1112 (and/or the algorithm 1100) may include, for example, but are not limited to, any known or practicable: (i) communication protocols and/or algorithms, (ii) Al and/or ML data input classification algorithms, (iii) data transmission algorithms, (iv) data encoding algorithms, (v) data decoding algorithms, (vi) logical and/or mathematical data comparison algorithms, and (vii) data searching (e.g., keyword searching) algorithms.

### V. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a "user device" or a "network device". As used herein, the terms "user device" and "network device" may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a "user" may generally refer to any individual and/or entity that operates a user device. Users may comprise, for example, customers, consumers, product underwriters, product distributors, customer service representatives, agents, brokers, etc.

As used herein, the term "network component" may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a "network" or a "communication network". As used herein, the terms "network" and "communication network" may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002@ published by the Institute of Electrical and Electronics Engineers (IEEE). In some embodiments, a network may include one or more wired and/or wireless networks operated in accordance with any communication standard or protocol that is or becomes known or practicable.

As used herein, the terms "information" and "data" may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by "Internet Protocol Version 6 (IPv6) Specification" RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an "indication". As used herein, the term "indication" may be used to refer to any indicia and/or other information indicative of or associated with a subject, item, entity, and/or other object and/or idea. As used herein, the phrases "information indicative of' and "indicia" may be used to refer to any information that represents, describes, and/or is otherwise associated with a related entity, subject, or object. Indicia of information may include,for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

"Determining" something can be performed in a variety of manners and therefore the term"determining" (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A "processor" generally means any one or more microprocessors, CPU devices, computing devices, microcontrollers, digital signal processors, or like devices, as further described herein.

The term "computer-readable medium" refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH- EEPROM, any other memory chip or cartridge, a carrier wave, or any other medium from which a computer can read.

The term "computer-readable memory" may generally refer to a subset and/or class of computer- readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as BluetoothTM, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel@ Pentium@ or Centrino^{T}M processor, that are adapted to communicate with the computer. Any number and type of machines may be in communication with the computer.

The indefinite articles "a" and "an," as used herein in the specification and in the claims, unlessclearly indicated to the contrary, should be understood to mean "at least one." This rule applies even within the body of a claim where a first instance of an element utilizes "a" or "an" and a second or subsequent instance of the element necessarily utilizes (e.g., for purposes of proper grammar and required antecedent basis) the definite article "the" to refer to the element. The use of the definite article "the" does not limit the element to a single object merely because it is utilized to refer back to a previous mention of the element. The original reference to the element controls with respect to the plurality (or lack thereof) of the element.

The phrase "and/or," as used herein in the specification and in the claims, should be understood to mean "either or both" of the elements so conjoined, i.e., elements that are conjunctively present in some cases and disjunctively present in other cases. Other elements may optionally be present other than the elements specifically identified by the "and/or" clause, whether related or unrelated to those elements specifically identified, unless clearly indicated to the contrary.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

What is claimed is:

1. A system for automated Graph Database (GDB) entitlement management, comprising:
an entitlements controller comprising a plurality of electronic processing devices;
a plurality of specially-programmed adapters in communication with the entitlements controller;
a non-transitory Graph Database (GDB) in communication with the entitlements controller, the GDB storing a plurality of data records descriptive of a plurality of nodes and a plurality of relationships between nodes;
an event manager programmed and communicatively coupled to identify events occurring within the GDB and to publish the GDB events; and
a non-transitory memory device in communication with the entitlements controller, the non- transitory memory device storing instructions that when executed by the plurality of electronic processing devices, result in:
registering, in the GDB and by the entitlements controller, a plurality of resources of a networked environment, wherein data descriptive of the plurality of resources defines the plurality of nodes and a plurality of relationships between nodes;
outputting, by the entitlements controller, a Graphical User Interface (GUI) providing interactive graphical elements representing a set of the plurality of nodes and a plurality of relationships between nodes;
receiving, by the entitlements controller and via the GUI, an indication of a request to change at least one node or relationship in the GDB;
submitting, by the entitlements controller and to the GDB, the request;
identifying, by the event manager and by listening to the GDB, an event corresponding to the submitted request; publishing, by the event manager and in response to the identifying, an indication of the event corresponding to the submitted request;
identifying, by at least one of the adapters from the plurality of specially-programmed adapters and by listening to the publication from the event manager, the event corresponding to the submitted request;
comparing, by the at least one of the adapters, data descriptive of the event corresponding to the submitted request to at least one stored criteria;
identifying, by the at least one of the adapters and based on the comparing, that the event corresponding to the submitted request satisfies the at least one stored criteria; and
transforming, by the at least one of the adapters, based on the identifying that the event corresponding to the submitted request satisfies the at least one stored criteria, and in response to the identifying that the event corresponding to the submitted request satisfies the at least one stored criteria, a system setting corresponding to the submitted request.

2. The system of claim 1, wherein the instructions, when executed by the plurality of electronic processing devices, further result in:
transmitting, after the transforming and by the entitlements controller and via the GUI, a confirmation that the submitted request has been implemented.

3. The system of claim 1, wherein the receiving of the indication of the request to change the at least one node or relationship in the GDB, comprises:
receiving, by the entitlements controller and via the GUI, an indication of a selection of one of the graphical elements corresponding to the indicated at least one node or relationship.

4. The system of claim 1, wherein the instructions, when executed by the plurality of electronic processing devices, further result in:
marking, by the entitlements controller and after the receiving, the request to change the at least one node or relationship in the GDB, as pending.

5. The system of claim 4, wherein the instructions, when executed by the plurality of electronic processing devices, further result in:
setting, by the entitlements controller, a time-to-live for the request to change the at least one node or relationship in the GDB.

6. The system of claim 4, wherein the instructions, when executed by the plurality of electronic processing devices, further result in:
marking, by the entitlements controller and after the transforming, the request to change the at least one node or relationship in the GDB, as active.

7. The system of claim 1, wherein the at least one node or relationship in the GDB corresponding to the requested change comprises at least one of:
(i) a physical data storage device;
(ii) a physical networking device; and (iii) a physical computing device.

8. The system of claim 7, wherein the at least one node or relationship in the GDB correspondingto the requested change comprises a physical data storage device comprising at least one database instance.

9. The system of claim 7, wherein the at least one node or relationship in the GDB corresponding to the requested change comprises a physical networking device comprising at least one of a firewall device and a networking switch device.

10. The system of claim 7, wherein the at least one node or relationship in the GDB corresponding to the requested change comprises a physical computing device comprising at least one user device.

11. The system of claim 1, wherein the at least one node or relationship in the GDB corresponding to the requested change comprises at least one of:
(i) an Active Directory (AD) setting;
(ii) an access control permissions setting;
(iii) a firewall port setting; and (iv) a network communications load- balancing setting.

12. The system of claim 1, wherein the request to change the at least one node or relationship in the GDB comprises a request to perform one or more of:
(i) creating a new node;
(ii) creating a new relationship;
(iii) modifying an existing node;
(iv) modifying an existing relationship; (v) deleting an existing node; and (vii) deleting an existing relationship.

13. The system of claim 1, wherein the instructions, when executed by the plurality of electronic processing devices, further result in:
receiving, by the entitlements controller, and after the transforming, an indication of a request to fix the change of the at least one node or relationship in the GDB;
querying the events manager for all events related to the change of the at least one node or relationship in the GDB; and
storing, based on a result of the query, a plurality of events in a republication queue.

14. The system of claim 13, wherein the fix comprises a request to fix a broken one of the specially-programmed adapters, and wherein the instructions, when executed by the plurality of electronic processing devices, further result in:
identifying the one of the specially-programmed adapters that is broken;
fixing the broken one of the specially-programmed adapters; and
republishing, by the events manager and in response to the identifying, an indication of the events stored in the republication queue.

15. The system of claim 14, wherein the events stored in the republication queue comprise a plurality of events that occurred at specific times and in a specific order as a result of the request to change the at least one node or relationship in the GDB.
